(19) United States
(12) Patent Application Publication
(10) Pub. No.: US 2014/0006882 A1
(43) Pub. Date: Jan. 2, 2014

(54) SCREEN GENERATION PROGRAM, SCREEN GENERATION APPARATUS, AND SCREEN GENERATION METHOD

(71) Applicant: FUJITSU LIMITED, Kawasaki-shi (JP)

(72) Inventors: Ken YOKOYAMA, Kawasaki (JP); Kazumi KUBOTA, Kawasaki (JP)

(73) Assignee: FUJITSU LIMITED, Kawasaki-shi (JP)

(21) Appl. No.: 14/019,021

(22) Filed: Sep. 5, 2013

Related U.S. Application Data
(63) Continuation of application No. 11/785,564, filed on Apr. 18, 2007, now abandoned.
Application No. 11/785,564 is a continuation-in-part of application No. 11/475,066, filed on Jun. 27, 2006, now abandoned.

(30) Foreign Application Priority Data
Mar. 13, 2006 (JP) 2006-067016
Jan. 12, 2007 (JP) 2007-004026

(51) Int. Cl. G06F 11/07

(52) U.S. Cl. CPC G06F 11/0766
USPC 714/57

(57) ABSTRACT

The present invention has been made to provide a screen generation program, a screen generation apparatus, and a screen generation method that generate a screen displayed on a client. A screen generation program allows a computer to execute: an acquisition step that acquires first data which is data sent from a server to client and which allows the client to display a first screen for receiving operation performed by a user and second data which is data sent from the client to server and which indicates the operation received by the first screen displayed on the client; and a generation step that generates, based on the first and second data acquired by the acquisition step, third data for displaying a second screen obtained by adding operation information which is based on the second data to the first screen.

### CROSS-REFERENCE TO RELATED APPLICATIONS

This application is a continuation of U.S. application Ser. No. 11/785,564, filed Apr. 18, 2007, which is a continuation-in-part of U.S. application Ser. No. 11/475,066, filed Jun. 27, 2006, which claims foreign priority to Japanese application 2006-067016, filed Mar. 13, 2006, and Japanese application 2007-004026, filed Jan. 12, 2007, and which are incorporated herein by reference in their entireties.

### BACKGROUND OF THE INVENTION

1. Field of the Invention

The present invention relates to a screen generation program, a screen generation apparatus, and a screen generation method that generate a screen displayed in a client.

2. Description of the Related Art

In a Web service which is provided from a Web server to a client by the client's access to the Web server, any trouble in the client which is caused by user's operation has been solved through a phone call from a user to a call center.

As a prior art relating to the present invention, there is a processing request restoration system (refer to, e.g., Patent Document 1: Jpn. Pat. Appln. Laid-Open Publication No. 2003-6018), in which in the case where a Web server malfunctions, a client uses its stored operation log records to restore processing up to stopping time to thereby allow a user of the client to continue subsequent processing in a seamless manner.

However, in the case where trouble is caused by operation on the client side as described above, the call center can only acquire information such as operation history, error log, and customer information recorded on the Web server side and does not grasp the detailed operation and screen on the client side.

The technique disclosed in Patent Document 1 is a technique applicable to a case where trouble caused on the Web server side is solved and therefore cannot solve trouble caused by operation on the client side. Further, the technique disclosed in Patent Document 1 is a technique used for the purpose of continuing processing of a client before and after the trouble and is performed only by the client side. That is, the Web server and call center are uninvolved in the above restoration technique.

The present invention has been made to solve the above problem, and an object thereof is to provide a screen generation program, a screen generation apparatus, and a screen generation method that generate a screen displayed on a client.

### SUMMARY OF THE INVENTION

To solve the above problems, according to a first aspect of the present invention, there is provided a screen generation program allowing a computer other than a client to generate a screen which is displayed on the client in association with communication between the client and a server, comprising: an acquisition step that acquires first data which is data sent from the server to client and which allows the client to display a first screen for receiving operation performed by a user and second data which is data sent from the client to server and which indicates the operation received by the first screen displayed on the client; and a generation step that generates, based on the first and second data acquired by the acquisition step, third data for displaying a second screen obtained by adding operation information which is based on the second data to the first screen.

According to a second aspect of the present invention, there is provided a screen generation apparatus that generates a screen which is displayed on a client in association with communication between the client and a server, comprising: an acquisition section that acquires first data which is data sent from the server to client and which allows the client to display a first screen for receiving operation performed by a user and second data which is data sent from the client to server and which indicates the operation received by the first screen displayed on the client; and a generation section that generates, based on the first and second data acquired by the acquisition section, third data for displaying a second screen obtained by adding operation information which is based on the second data to the first screen.

According to a third aspect of the present invention, there is provided a screen generation method that executes generation of a screen which is displayed on a client in association with communication between the client and a server in an information processing apparatus other than the client, comprising: an acquisition step that acquires first data which is data sent from the server to client and which allows the client to display a first screen for receiving operation performed by a user and second data which is data sent from the client to server and which indicates the operation received by the first screen displayed on the client; and a generation step that generates, based on the first and second data acquired by the acquisition step, third data for displaying a second screen obtained by adding operation information which is based on the second data to the first screen.

According to the present invention, it is possible to generate a screen displayed on a client, including user's entry for the client.

### BRIEF DESCRIPTION OF THE DRAWINGS

FIG. 1 is a block diagram showing a configuration example of a Web system according to a first embodiment;

FIG. 2 is a block diagram showing a configuration example of a screen reproduction apparatus according to the first embodiment;

FIG. 3 is a table showing an example of an operation log according to the first embodiment;

FIG. 4 is a table showing an example of an error log according to the first embodiment;

FIG. 5 is a table showing an example of the data structure of an HTTP request message;

FIG. 6 is a table showing an example of the data structure of an HTTP response message;

FIG. 7 is a sequence diagram showing an example of the HTTP message;

FIG. 8 is a flowchart showing an example of operation of communication data acquisition processing according to the first embodiment;

FIG. 9 is a flowchart showing an example of operation of HTTP protocol analysis processing according to the first embodiment;

FIG. 10 is a table showing an example of the contents of a communication data storage section 113 according to the first embodiment;

FIG. 11 is a flowchart showing an example of operation of communication data extraction processing according to the first embodiment;

FIG. 12 is a flowchart showing an example of operation of screen data generation processing according to the first embodiment;

FIG. 13 is a flowchart showing an example of operation of response input embedding processing according to the first embodiment;

FIG. 14 is a view showing a concrete example of operation of the response input embedding processing according to the first embodiment;

FIG. 15 is a table showing an example of the contents of a screen data storage section according to the first embodiment;

FIG. 16 is a view showing an example of a GUI according to the first embodiment;

FIG. 17 is a flowchart showing an example of operation of screen control processing according to the first embodiment;

FIG. 18 is a view showing a concrete example of screens displayed on a screen display section according to the first embodiment;

FIG. 19 is a block diagram showing an example of the data structure of screen additional information according to the first embodiment;

FIG. 20 is a table showing an example of the content of an operation—HTML form association table according to the first embodiment;

FIG. 21 is a table showing an example of the content of an error content-response input argument association table according to the first embodiment;

FIG. 22 is a table showing an example of the content of a response input assistance message table according to the first embodiment;

FIG. 23 is a view showing an example of information used for display of a first concrete example according to the first embodiment;

FIG. 24 is a view showing an example of a GUI display in the first concrete example according to the first embodiment;

FIG. 25 is a view showing an example of screen data in the second concrete example according to the first embodiment;

FIG. 26 is a view showing an example of a GUI display in the second concrete example according to the first embodiment;

FIG. 27 is a view showing a first state of a share purchase screen displayed on the client;

FIG. 28 is a view showing a second state of the share purchase screen displayed on the client;

FIG. 29 is a view showing a third state of the share purchase screen displayed on the client;

FIG. 30 is a view showing a fourth state of the share purchase screen displayed on the client;

FIG. 31 is a view showing a first state of a trading decision screen displayed on the client;

FIG. 32 is a view showing a fifth state of the share purchase screen displayed on the client;

FIG. 33 is a view showing an example of a thumbnail view displayed on the screen reproduction apparatus according to the first embodiment;

FIG. 34 is a block diagram showing an example of a configuration of a screen reproduction apparatus according to a second embodiment;

FIG. 35 is a flowchart showing an example of operation of screen reproduction processing according to the second embodiment;

FIG. 36 is a flowchart showing an example of operation of reproduction target data aggregation processing according to the second embodiment;

FIG. 37 is a table showing an example of a reproduction target record extraction table according to the second embodiment;

FIG. 38 is a table showing an example of the content of a reproduction target aggregation table according to the second embodiment;

FIG. 39 is a flowchart showing an example of operation of response record analysis processing according to the second embodiment;

FIG. 40 is a flowchart showing an example of operation of request record analysis processing according to the second embodiment;

FIG. 41 is a flowchart showing an example of operation of transition number addition processing according to the second embodiment;

FIG. 42 is a flowchart showing an example of operation of screen transition order addition processing according to the second embodiment;

FIG. 43 is a flowchart showing an example of operation of depressed button order addition processing according to the second embodiment;

FIG. 44 is a flowchart showing an example of operation of data transition addition processing according to the second embodiment;

FIG. 45 is a view showing an example of the content of a data transition management table A according to the second embodiment;

FIG. 46 is a view showing an example of the content of a data transition management table B according to the second embodiment;

FIG. 47 is a table showing an example of the content of a screen image form DB according to the second embodiment;

FIG. 48 is a table showing an example of the content of a button overwrite information DB according to the second embodiment;

FIG. 49 is a table showing an example of the content of a data overwrite information DB according to the second embodiment;

FIG. 50 is a flowchart showing an example of operation of reproduction image creation processing according to the second embodiment;

FIG. 51 is a flowchart showing an example of operation of data overwrite processing according to the second embodiment;

FIG. 52 is a flowchart showing an example of operation of reproduction image display processing according to the second embodiment;

FIG. 53 is a view showing an example of a reproduction screen according to the second embodiment;

FIG. 54 is a view showing an example of first screen image form data according to the second embodiment; and

FIG. 55 is a view showing an example of second screen image form data according to the second embodiment.

### DETAILED DESCRIPTION OF THE PREFERRED EMBODIMENTS

An embodiment of the present invention will be described below with reference to the accompanying drawings.

### First Embodiment

In the present embodiment, a screen reproduction apparatus that reproduces a screen displayed on a client that accesses a Web server is exemplified as a screen generation apparatus.

Firstly, a configuration of a Web system according to the present embodiment will be described.

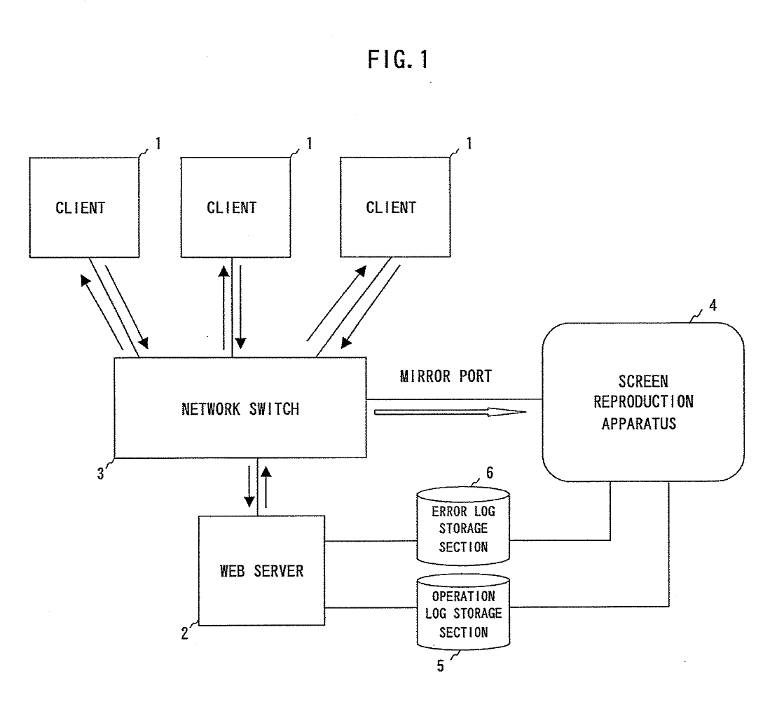

FIG. 1 is a block diagram showing a configuration example of a Web system according to the present embodiment. The Web system shown in FIG. 1 includes a client 1, a Web server 2, a network switch 3, a screen reproduction apparatus 4, an operation log storage section 5, and an error log storage section 6. The client 1 and Web server 2 are connected to each other via the network switch 3. The screen reproduction apparatus 4 is connected to a mirror port of the network switch 3. The operation log storage section 5 and error log storage section 6 are connected to both the Web server 2 and screen reproduction apparatus 4.

The client 1 is configured to access the Web server 2 according to a user's operation, display a Web page screen received from the Web server 2, and transmit a user's operation instruction made on the Web page screen to the Web server 2. The Web server 2 is configured to store a history of operations performed in the client 1 in the operation log storage section 5 as an operation log and store a history of errors occurring during communication with the client 1 in the error log storage section 6 as an error log. The network switch 3 is configured to capture communication between the client 1 and Web server 2 and transmit the captured communication to the screen reproduction apparatus 4 via the mirror port thereof.

A configuration of the screen reproduction apparatus will next be described.

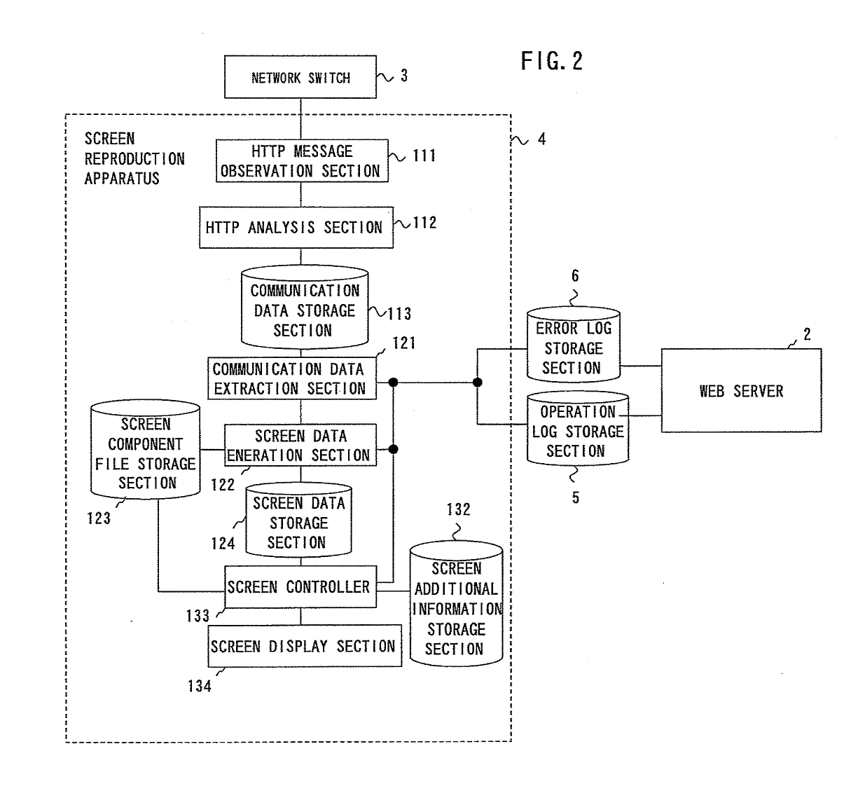

FIG. 2 is a block diagram showing a configuration example of the screen reproduction apparatus according to the present embodiment. The screen reproduction apparatus 4 shown in FIG. 2 includes an HTTP (HyperText Transfer Protocol) message observation section 111, an HTTP analysis section 112, a communication data storage section 113, a communication data extraction section 121, a screen data generation section 122, a screen component file storage section 123, a screen data storage section 124, a screen additional information storage section 132, a screen controller 133, and a screen display section 134.

An operation log in the operation log storage section 5 and an error log in the error log storage section 6 will next be described.

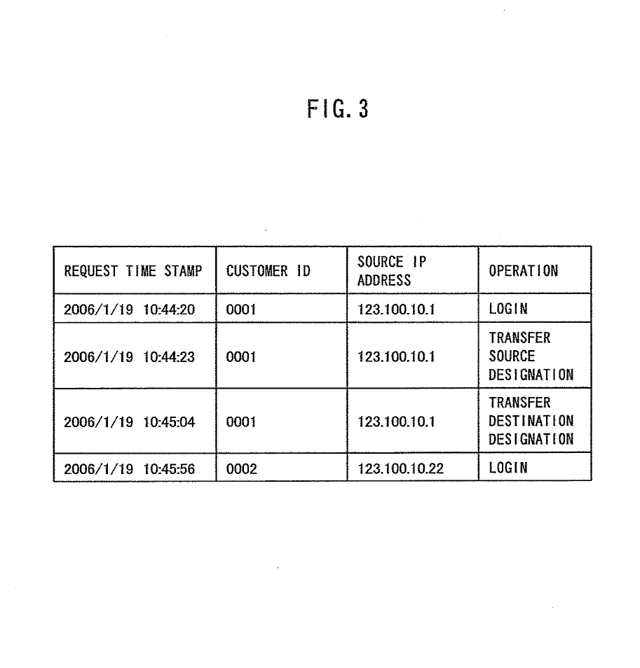

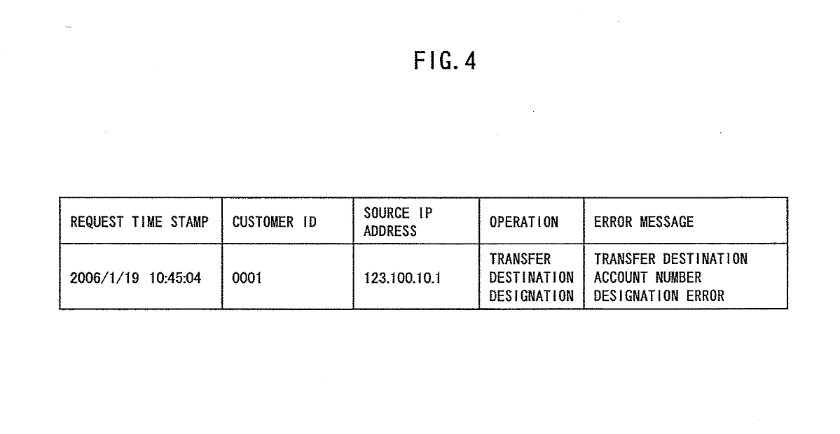

The operation log and error log are generated by the Web server 2, as is conventionally done. FIG. 3 is a table showing an example of the operation log according to the present embodiment. The operation log has a record corresponding to each operation. Each record contains four items: request time stamp, customer ID, source IP address, and operation. FIG. 4 is a table showing an example of the error log according to the present embodiment. The error log has a record corresponding to each error. Each record contains five items: request time stamp, customer ID, source IP address, operation, and error message.

An HTTP message captured by the network switch 3 will next be described.

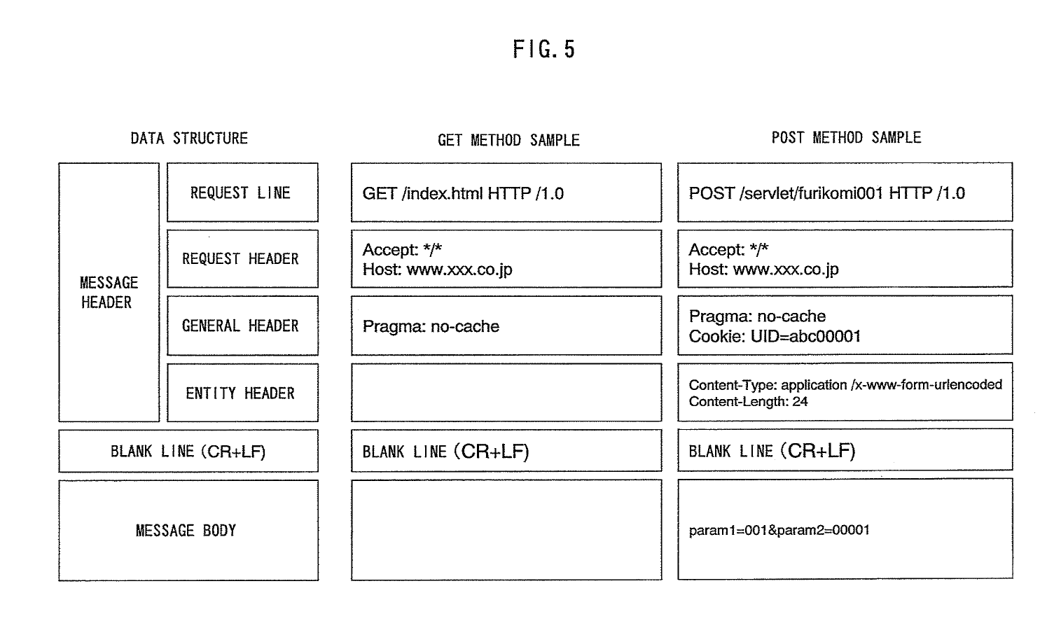

The data structure of a request (HTTP request message) to be transmitted from the client 1 to the Web server 2 will firstly be described. FIG. 5 is a table showing an example of the data structure of the HTTP request message. As shown in the leftmost column of FIG. 5, data of the HTTP request message consists of message header, blank line, and message body. The message header consists of request line, request header, general header, and entity header. The two columns on the right side of the table show concrete examples of the data structure of the request, i.e., data structure of GET method and that of POST method.

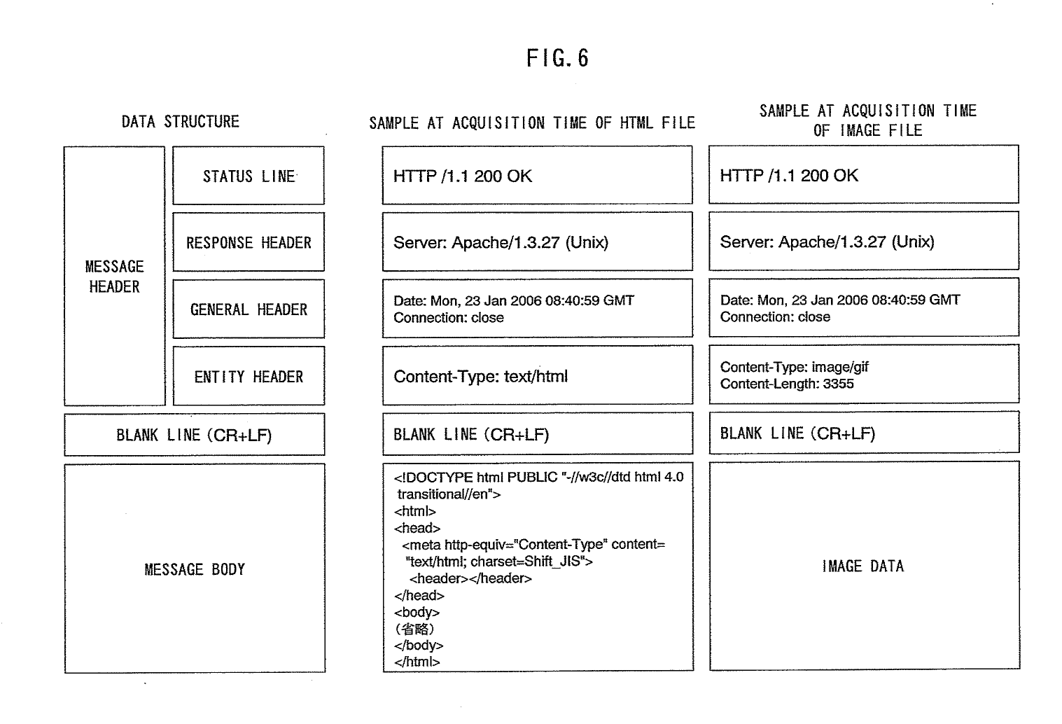

The data structure of a response (HTTP response message) to be transmitted from the Web server 2 to the client 1 will next be described. FIG. 6 is a table showing an example of the data structure of the HTTP response message. As shown in the leftmost column of FIG. 6, data of the HTTP response message consists of message header, blank line, and message body, as in the case of the HTTP request message. The message header consists of status line, response header, general header, and entity header. The two columns on the right side of the table show concrete examples of the data structure of the response sample, i.e., the data structure of the response at the acquisition time of an HTML (HyperText Markup Language) file and that of the response at the acquisition time of an image file.

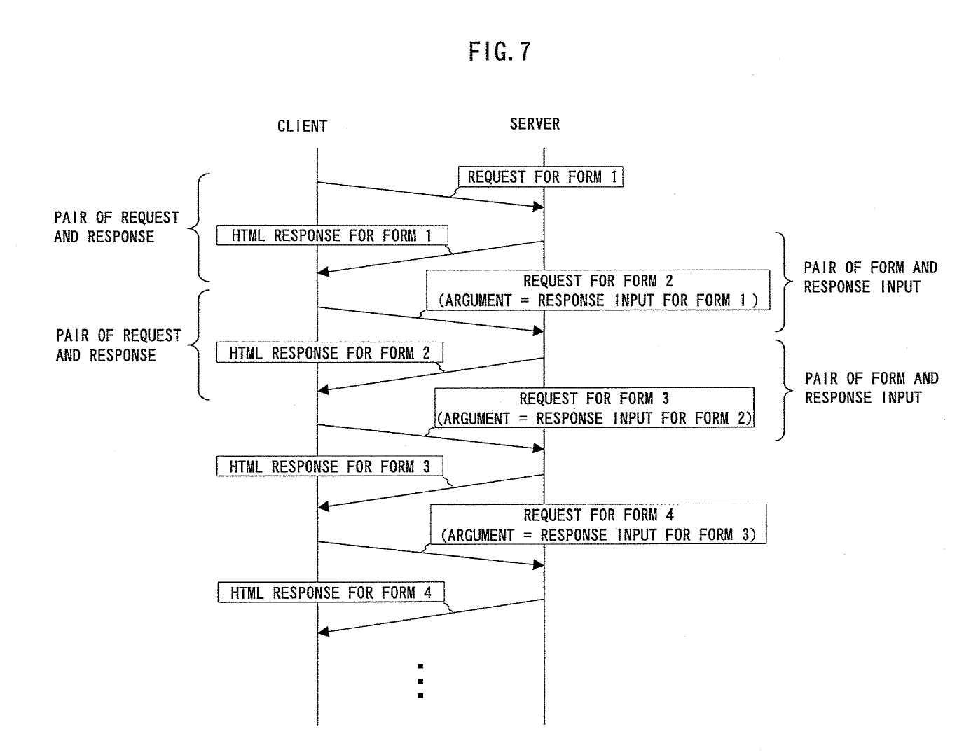

FIG. 7 is a sequence diagram showing an example of the HTTP message. In a sequence of HTTP message exchanges, a request and response alternately appear. A given request and a response appearing immediately after the request constitute a pair. A response input that a user has made on the client 1 with respect to a form in a given response becomes an argument to a request appearing immediately after the response. Accordingly, a form in a given response and a response input in a request appearing immediately after the response constitute a pair. The image reproduction apparatus 4 uses the above pairs to make an association between HTTP messages.

Communication data acquisition processing performed by the HTTP message observation section 111 and HTTP analysis section 112 will next be described.

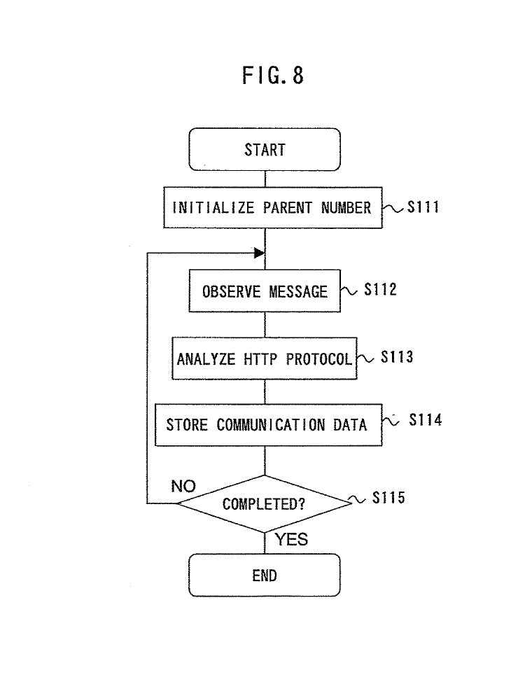

FIG. 8 is a flowchart showing an example of operation of the communication data acquisition processing according to the present embodiment. An ID (identification) to be assigned to the HTTP message is represented in a form of “(parent number)-(child number)”. The HTTP message observation section 111 initializes the parent number (parent number=0) (S111), extracts the HTTP message from a message captured by the network switch 3, and transmits the extracted HTTP message to the HTTP analysis section 112 (S112). The HTTP analysis section 112 performs HTTP protocol analysis for the received HTTP message (S113) and stores a result of the analysis in the communication data storage section 113 as communication data (S114). The HTTP message observation section 111 determines whether the observation of all messages has been completed (S115). If the observation of all messages has not been completed (N in S115), the flow returns to step S112. If the observation of all messages has been completed (Y in S115), this flow is ended.

HTTP protocol analysis performed during communication data acquisition processing will next be described.

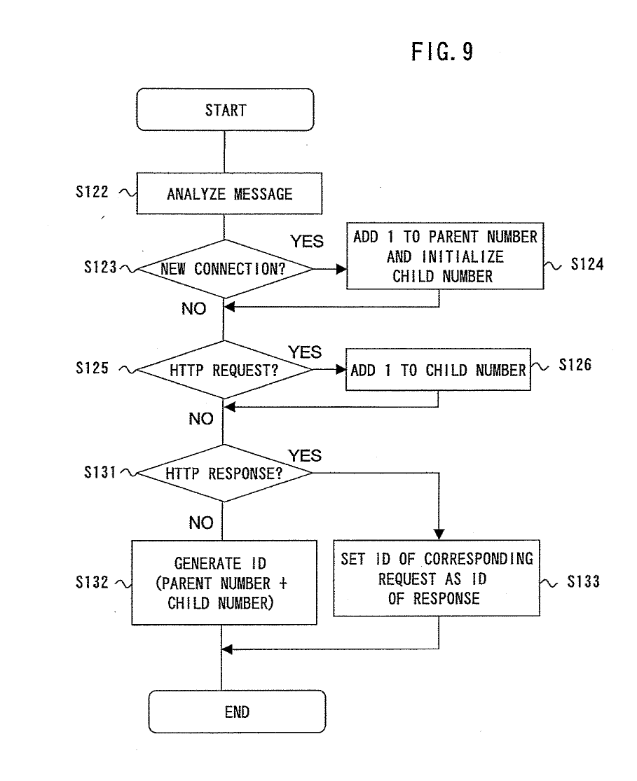

FIG. 9 is a flowchart showing an example of operation of the HTTP protocol analysis according to the present embodiment. The HTTP analysis section 112 analyzes the HTTP message received from the HTTP message observation section 111 (S122) and determines whether the received HTTP message is a new connection (new session, new screen) (S123). If the received message is not a new connection (N in S123), the flow shifts to step S125. If the received message is a new connection (Y in S123), the HTTP analysis section 112 adds 1 to the parent number and initializes the child number (sets the child number to 1) (S124). The HTTP analysis section 112 then determines whether the received message is a request (S125). If the received message is not a request (N in S125), the flow shifts to step S131. If the received message is a request (Y in S125), the HTTP analysis section 112 adds 1 to the child number (S126).

The HTTP analysis section 112 then determines whether the received HTTP message is a response (S131). If the received message is not a response (N in S131), the HTTP analysis section 112 registers the ID consisting of the parent number and child number in the communication data storage section 113 (S132) and this flow is ended. If the received message is a response (Y in S131), the HTTP analysis section 112 registers the ID of a request (a request immediately before a response with which the request constitutes a pair) having a source IP address, a source port number, a destination IP address, and a destination port number all of which correspond to those of the response in the communication data storage section 113 as an ID of the response (S133), and this flow is ended.

The data structure of the communication data storage section 113 will next be described.

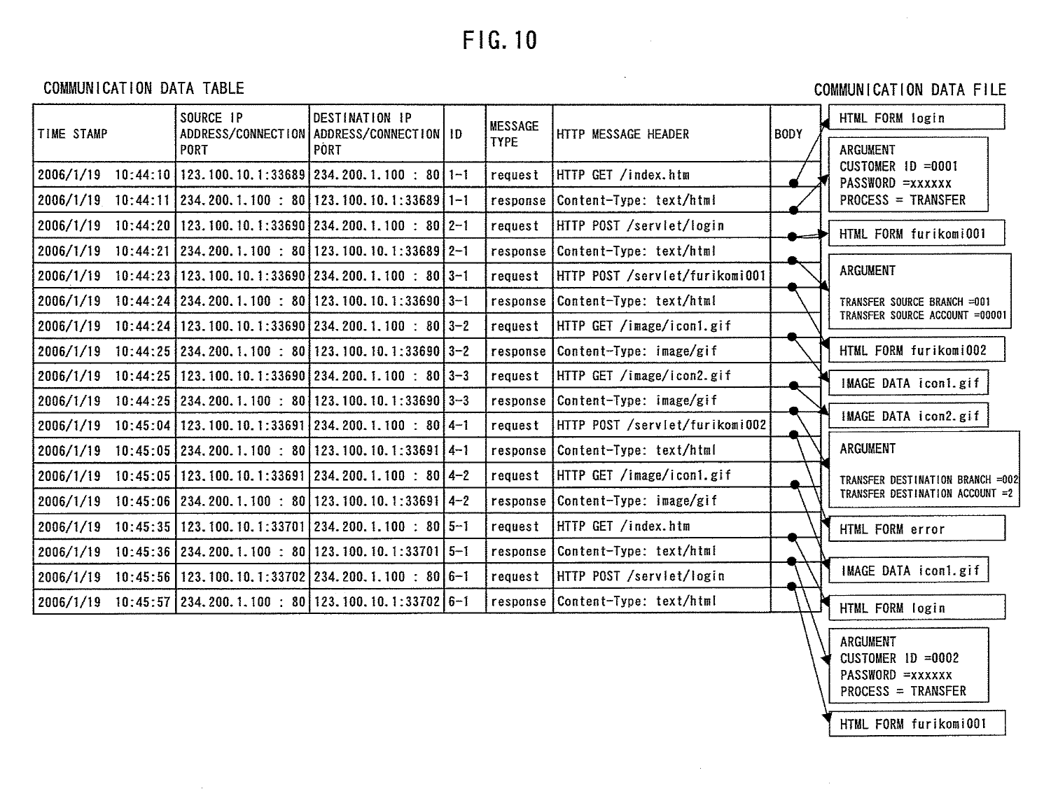

FIG. 10 is a table showing an example of the contents of the communication data storage section 113 according to the present embodiment. The communication data storage section 113 stores, as communication data, a communication data file which is a message body of the HTTP message and a communication data table that manages the communication data file in the form of a table. The communication data table has a record corresponding to each HTTP message. Each record contains seven items: time stamp, source IP (Internet Protocol) address/connection port, destination IP address/connection port, ID, message type, HTTP message header, and body.

The ID is assigned by the abovementioned HTTP protocol analysis. The ID has an identical parent number in a connection of one screen and an identical child number between a pair of request and response messages. The message type indicates that a message is a request or a response. The body is a file name of a communication data file which is a message body of the corresponding HTTP message. The communication data file includes an HTML form, an argument (response input to HTML form) of the HTTP message, image data, and the like.

As described above, the HTTP message observation section 111 and HTTP analysis section 112 performs the communication data acquisition processing to analyze the HTTP massage exchanged between the client 1 and the Web server 2 and generate the communication data table, making it easy to make an association between communication data and error log as well as making it easy to extract a pair of request and response messages or a pair of a form and a response input from between the HTTP messages.

Communication data extraction processing performed by the communication data extraction section 121 will next be described.

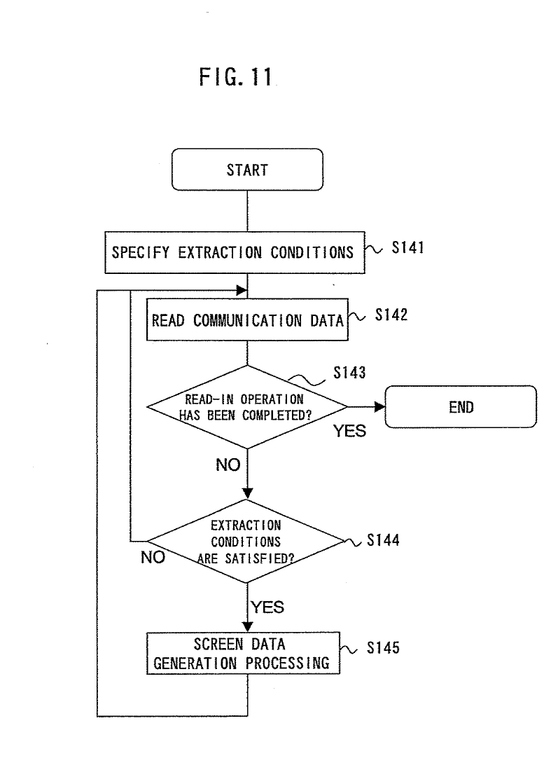

FIG. 11 is a flowchart showing an example of operation of the communication data extraction processing according to the present embodiment. The communication data extraction section 121 specifies extraction conditions with reference to information stored in the error log storage section 6 (S141) and reads an HTTP message from the communication data storage section 113 (S142). The extraction conditions include, e.g., an HTTP message corresponding to an error that a user of the screen reproduction apparatus 4 has specified from among error log entries and HTTP messages related to the HTTP message corresponding to an error (in other words, HTTP messages included in a predetermined range before and after the HTTP message corresponding to an error). The HTTP message corresponding to an error is, e.g., an HTTP massage having a corresponding request time stamp or source IP address in the error log.

Although extraction conditions are specified based on the error log in the above case, the conditions may be specified based on the operation log.

The communication data extraction section 121 then determines whether the reading operation of all HTTP messages in the communication data storage section 113 has been completed (S143). If the reading operation of all HTTP messages has been completed (Y in S143), this flow is ended. If the reading operation of all HTTP messages has not been completed (N in S143), the communication data extraction section 121 determines whether an HTTP message that has just been read satisfies the extraction conditions (S144). If the HTTP message does not satisfy the conditions (N in S144), the flow returns to step S142 where the communication data extraction section 121 reads a subsequent communication data. If the HTTP message satisfies the conditions (Y in S144), the communication data extraction section 121 sends the read HTTP message to the screen data generation section 122, which performs screen data generation processing (S145). The flow returns to step S142 and the communication data extraction section 121 reads a subsequent data.

The screen data generation processing that the screen data generation section 122 performs during the communication data extraction processing will next be described.

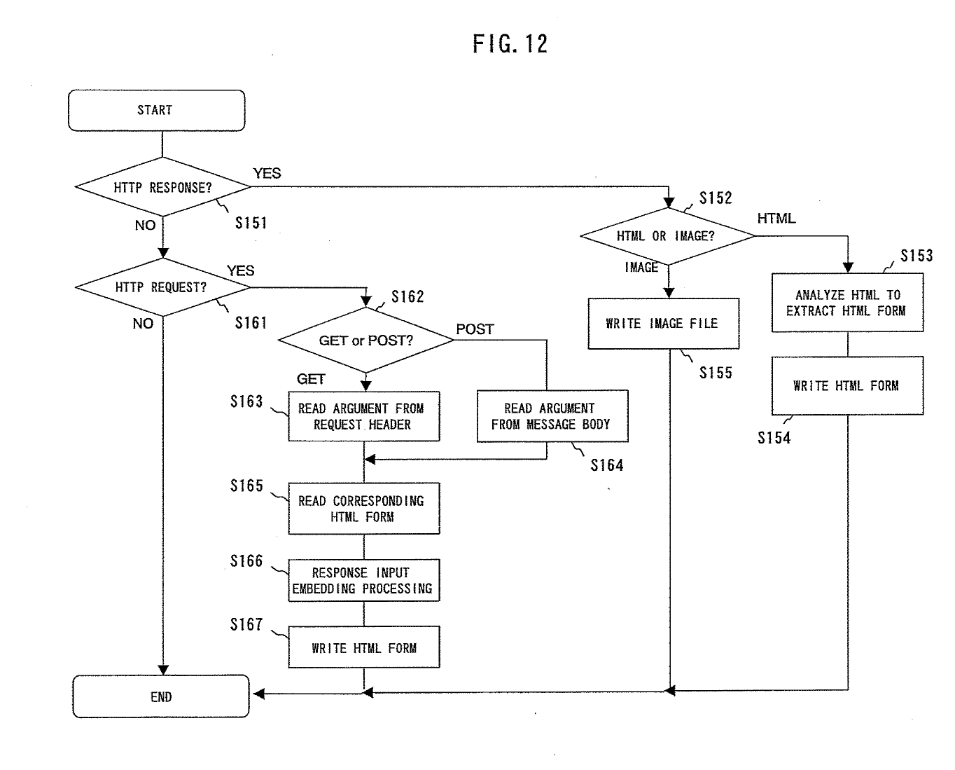

FIG. 12 is a flowchart showing an example of operation of the screen data generation processing according to the present embodiment. The screen data generation section 122 determines whether an HTTP message received from the communication data extraction section 121 is a response (S151).

If the HTTP message is a response (Y in S151), the screen data generation section 122 determines whether the response is an HTML or an image (S152). If the response is an HTML (HTML in S152), the screen data generation section 122 analyzes the HTML to extract an HTML form (S153), writes the extracted HTML form in the screen component file storage section 123 as a screen component file (S154), and this flow is ended. If the response is an image (image in S152), the screen data generation section 122 writes the extracted image in the screen component file storage section 123 as an image component file (S155), and this flow is ended.

If the HTTP message is not a response (N in S151), the screen data generation section 122 determines whether the HTTP message received from the communication data extraction section 121 is a request (S161).

If the HTTP message is a request (Y in S161), the screen data generation section 122 determines whether the request is a GET or a POST (S162). If the request is a GET (GET in S162), the screen data generation section 122 reads an argument (response input) from the request header of the GET (S163), and the flow shifts to step S165. If the request is a POST (POST in S162), the screen data generation section 122 reads an argument (response input) from the message body of the POST (S164), and the flow shifts to step S165.

The screen data generation section 122 then reads a corresponding HTML form (extracted from a response immediately before the request) from the screen component file storage section 123 (S165), performs response input embedding processing to embed the response input in the read HTML form (S166), registers the resultant HTML form in the screen data storage section 124 as a screen data file (S167), and this flow is ended.

If the HTTP message is not a request (N in S161), this flow is ended.

The response input embedding processing performed during the screen data generation processing will next be described.

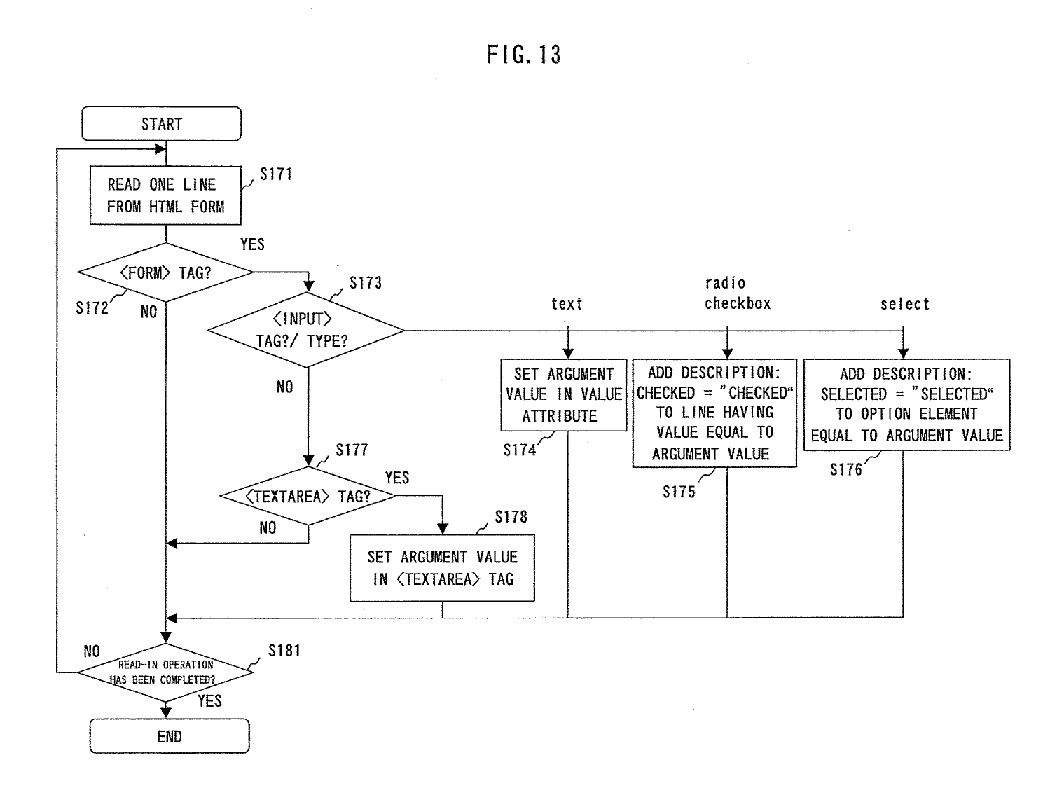

FIG. 13 is a flowchart showing an example of operation of the response input embedding processing according to the present embodiment. The screen data generation section 122 reads one line from the HTML form stored in the screen component file storage section 123 (S171) and determines whether a <form> tag exists in the read line (S172).

If a <from> tag does not exist (N in S172), the flow shifts to step S181.

If a <form> tag exists (Y in S172), the screen data generation section 122 determines whether an <input> tag exists in the read line (S173). If an <input> tag exists and its type is text (text in S173), the screen data generation section 122 sets an argument value in a value attribute (S174), and the flow shifts to step S181. If an <input> tag exists and its type is radio checkbox (radio checkbox in S173), the screen data generation section 122 adds a description: checked=“checked” to a line having a value equal to the argument value (S175), and the flow shifts to step S181. If an <input> tag exists and its type is select (select in S173), the screen data generation section 122 adds a description: selected=“selected” to an option element equal to the argument value (S176), and the flow is shifted to step S181.

If an <input> tag does not exist (No in S173), the screen data generation section 122 determines whether a <textarea> tag exists (S177). If a <textarea> tag does not exist (N in S177), the flow shifts to step S181. If a <textarea> tag exists (Y in S177), the screen data generation section 122 sets an argument value in the <textarea> tag (S178), and the flow shifts to step S181.

In step S181, the screen data generation section 122 determines whether the read-in operation of all lines in the HTML form has been completed (S181). If the read-in operation of all lines has been completed (Y in S181), this flow is ended. If the read-in operation of all lines has not been completed (N in S181), the flow returns to step S171 where the screen data generation section 122 reads a subsequent line.

A concrete example of an HTML form generated by the abovementioned response input embedding processing will next be described.

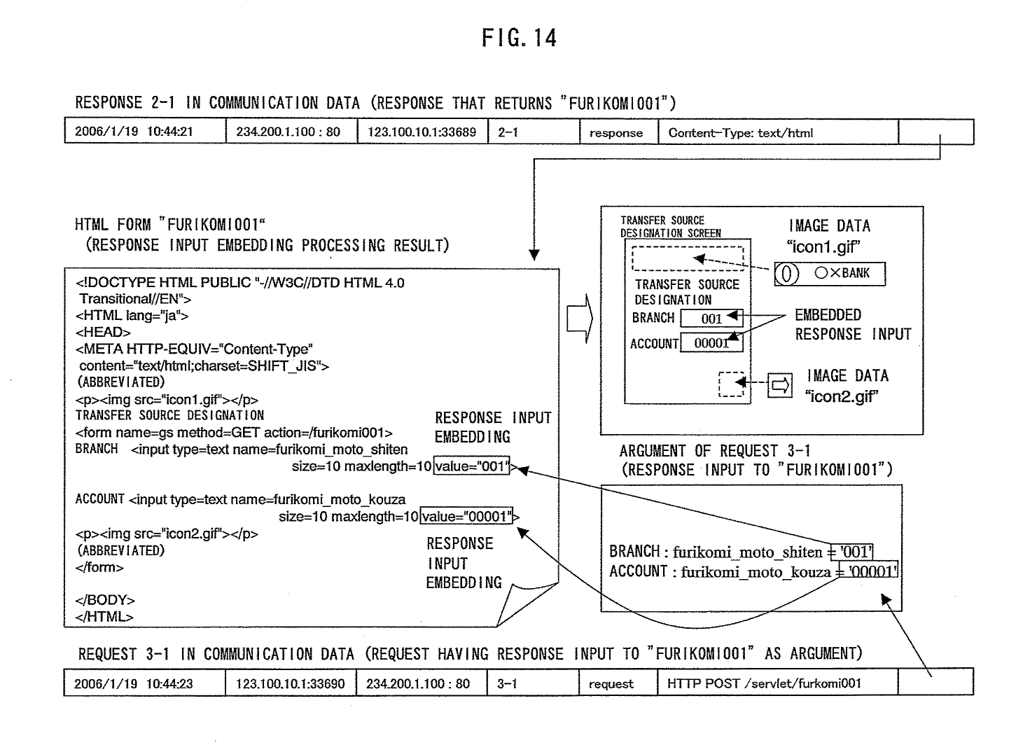

FIG. 14 is a view showing a concrete example of operation of the response input embedding processing according to the present embodiment. The drawing shows a relationship among an HTML form “furikomi001”, a record of an request 3-1 in the communication data table, an argument of the request 3-1 in the communication data file, a record of a response 2-1 in the communication data table, and a transfer source designation screen.

In FIG. 14, the HTML form “furikomi001” represents a result of the response input embedding processing. The request 3-1 is a request having a response input to the “furikomi001” as an argument. The argument of the request 3-1 is a response input to the “furikomi001”. The response 2-1 is a response that returns the “furikomi001” and is a response immediately before the request 3-1. The transfer source designation screen is a screen that is displayed based on a result obtained by embedding a response input in the HTML form “furikomi001”.

According to the abovementioned response input embedding processing, “value=001” and “value=00001” respectively indicating response inputs are embedded in two <input> tags in the HTML form “furikomi001”.

As described above, according to the screen data generation processing, it is possible to generate an HTML form in which a response has been input in the HTML form based on the error log stored in the Web server 2 and captured communication data.

The data structure of the screen data storage section 123 will next be described.

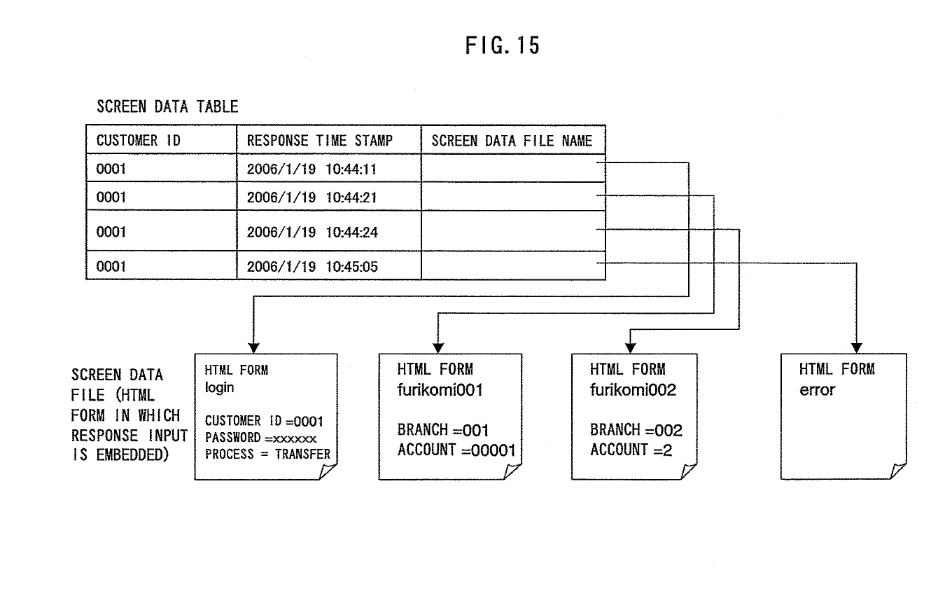

FIG. 15 is a table showing an example of the contents of the screen data storage section 123 according to the present embodiment. The screen data storage section 123 stores a screen data table and a screen data file. The screen data table has a record corresponding to each screen data. Each record contains three items: customer ID, response time stamp, and screen data file name. The screen data file name is linked to an HTML form generated by the response input embedding processing. The lower part of FIG. 15 shows, as a reference, screens displayed according to respective screen data files.

In step S167, the screen data generation section 122 acquires a customer ID of a corresponding operation from the operation log storage section 5, acquires a time stamp of a corresponding response from the communication data storage section 113, and registers the acquired customer ID and time stamp in the screen data table together with a screen data file name.

A GUI (Graphical User Interface) displayed by the screen display section 134 will next be described.

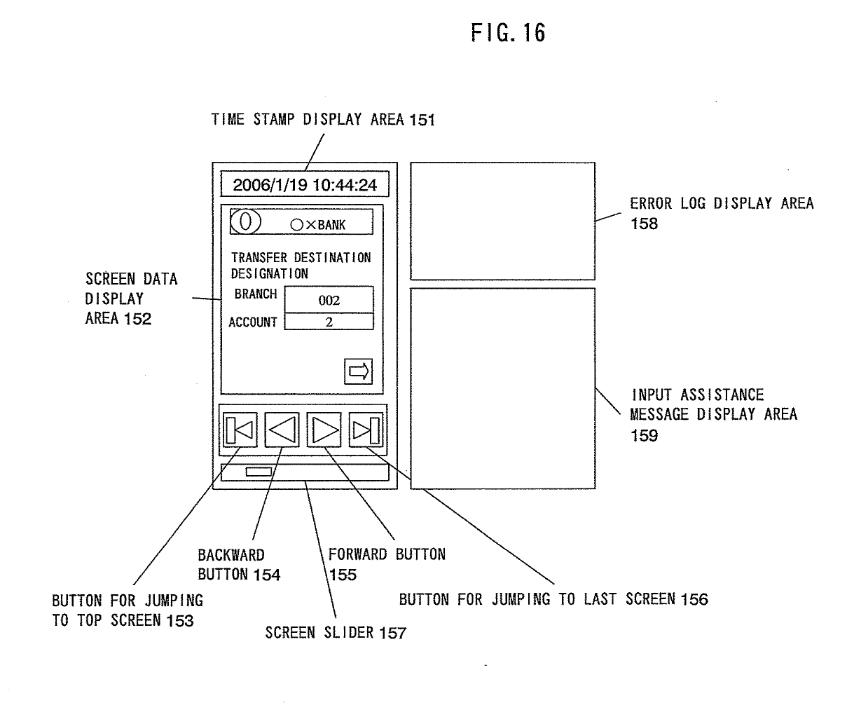

FIG. 16 is a view showing an example of a GUI according to the present embodiment. The GUI includes a time stamp display area 151, a screen data display area 152, a button 153 for jumping to top screen, a backward button 154, a forward button 155, a button 156 for jumping to last screen, a screen slider 157, an error log display area 158, and an input assistance message display area 159.

The time stamp display area 151 displays a time stamp of a screen data HTTP message. The screen data display area 152 displays screen data sent from the screen controller 133. The screen additional information display area 158 displays screen additional information sent from the screen controller 133. The button 153 for jumping to top screen, backward button 154, forward button 155, button 156 for jumping to last screen, and screen slider 157 receive user's operation to send the received operation to the screen controller 133.

Screen control processing performed by the screen controller 133 will next be described.

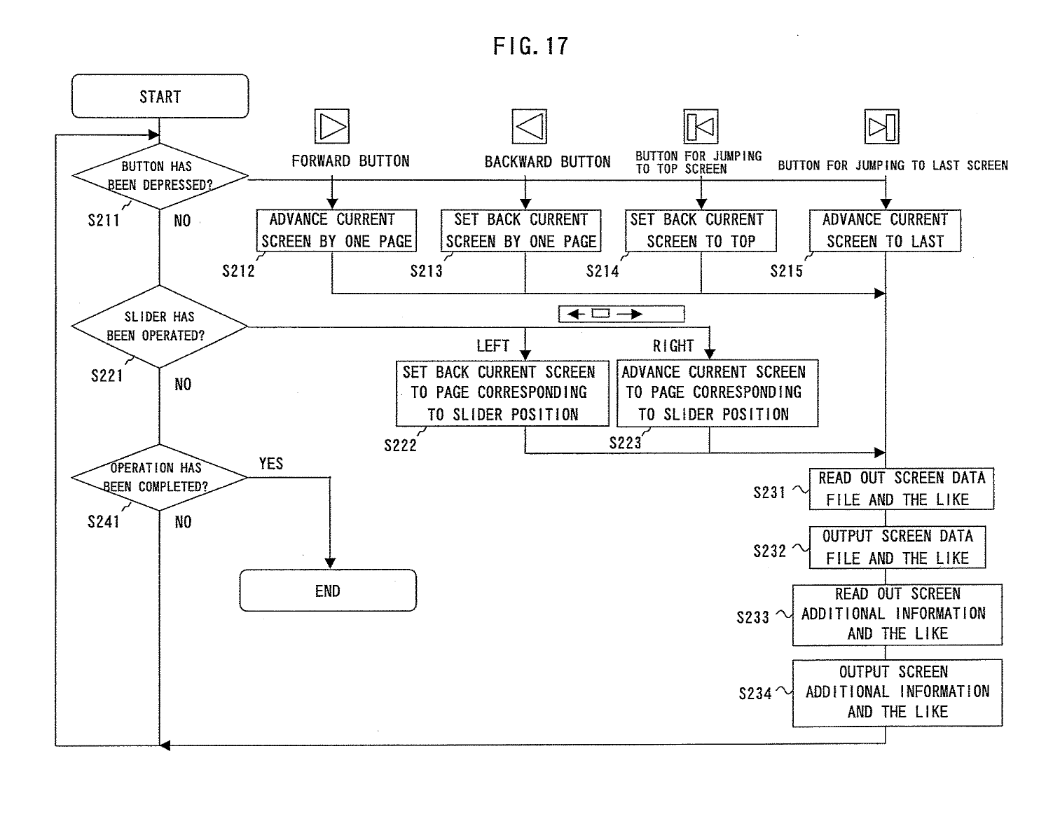

FIG. 17 is a flowchart showing an example of operation of the screen control processing according to the present embodiment. The screen controller 133 determines whether a button on the operation screen has been depressed by a user of the screen reproduction apparatus 4 (S211). If the forward button has been depressed (forward button in S211), the screen controller 133 advances the current screen by one page (S212), and the flow shifts to step S231. If the backward button has been depressed (backward button in S211), the screen controller 133 sets back the current screen by one page (S213), and the flow shifts to step S231. If the button for jumping to top screen has been depressed (button for jumping to top screen in S211), the screen controller 133 sets back the current screen to the top (S214), and the flow shifts to step S231. If the button for jumping last screen has been depressed (button for jumping to last screen in S211), the screen controller 133 advances the current screen to the last (S215), and the flow shifts to step S231.

If any button has not been depressed (NO in S211), the screen controller 133 determines whether the slider on the operation screen has been operated by a user of the screen reproduction apparatus 4 (S221). If the slider has been moved to the left (left in S221), the screen controller 133 sets back the current screen to a page corresponding to the slider position (S222), and the flow shifts to step S231. If the slider is moved to the right (right in S221), the screen controller 133 advances the current screen to a page corresponding to the slider position (S223), and the flow shifts to step S231.

In step S231, the screen controller 133 reads out a screen data file corresponding to a moved screen from the screen data storage section 124 as well as reads out a screen component file used in the screen data file from the screen data storage section 124 (S231) and allows the screen display section 134 to display the screen data file and screen component file (S232). Further, the screen controller 133 reads out an error log stored in the error log storage section 6 or screen additional information stored in the screen additional information storage section 132 (S233) and allows the screen display section 134 to display the error log or screen additional information (S234). The flow then shifts to step S211, where the screen controller 133 makes a determination about a subsequent operation.

If the slider has not been operated (No in S221), the screen controller 133 determines whether a user of the screen reproduction apparatus 4 has completed the operation with respect to the operation screen (S241). If the operation has not been completed (N in S241), the flow shifts to step S211, where the screen controller 133 makes a determination about a subsequent operation. If the operation has been completed (Y in S241), this flow is ended.

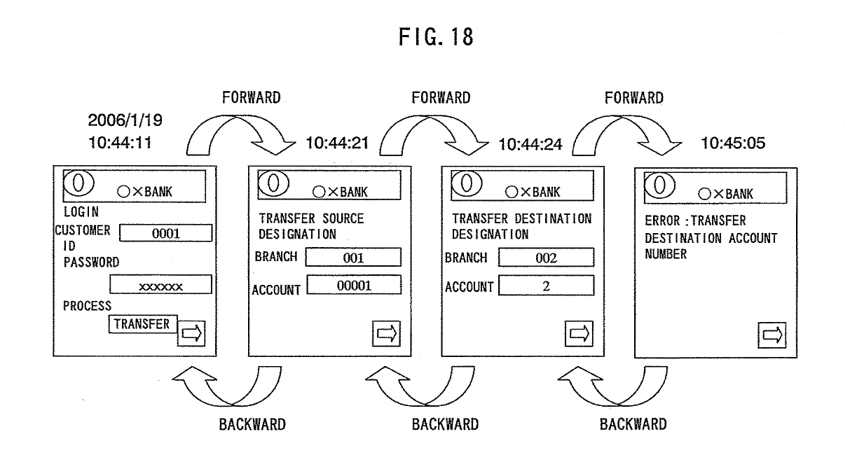

FIG. 18 is a view showing a concrete example of screens displayed on the screen display section according to the present embodiment. The screen displayed on the screen data display area 152 by the abovementioned screen control processing is a screen based on any of the four screen data files managed by the screen data table of FIG. 15. The screen to be displayed on the screen data display area 152 jumps among four screens according to the user's operation of depressing the forward button 155 or backward button 154.

The data structure of the screen additional information previously stored in the screen additional information storage section 132 will next be described.

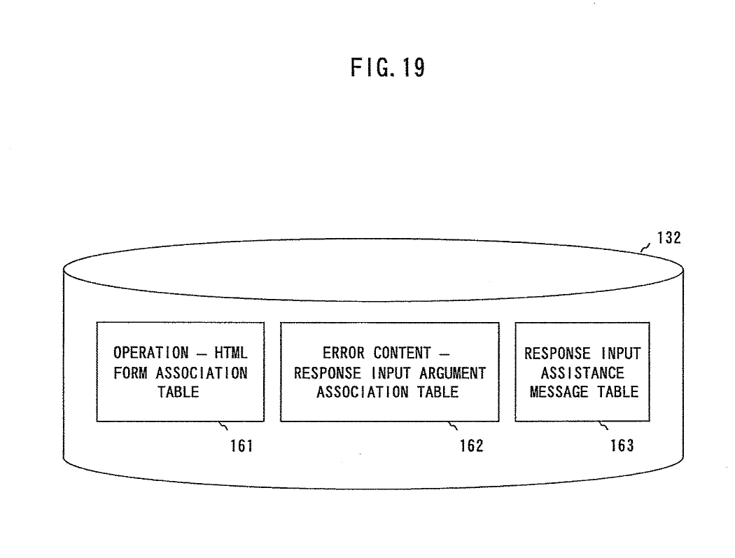

FIG. 19 is a block diagram showing an example of the data structure of the screen additional information according to the present embodiment. The screen additional information includes an operation—HTML form association table 161, an error content-response input argument association table 162, and a response input assistance message table 163.

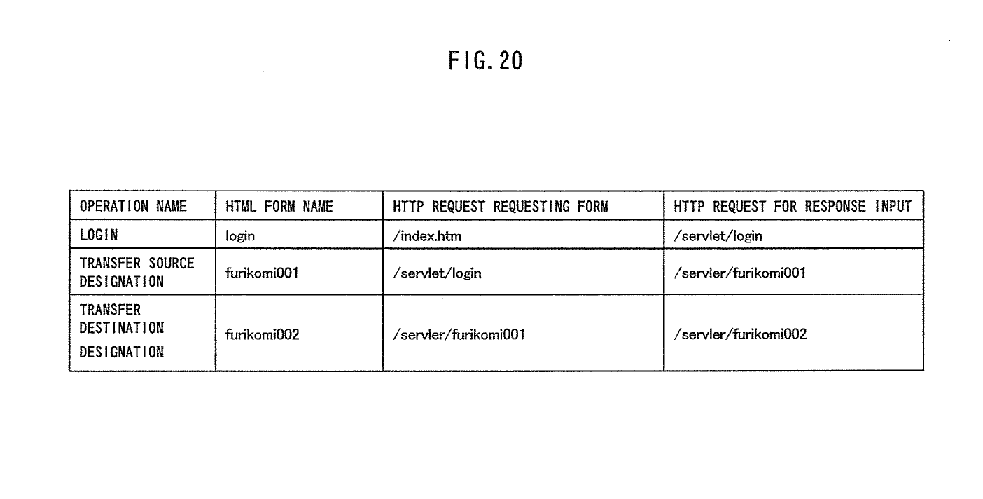

FIG. 20 is a table showing an example of the content of the operation—HTML form association table according to the present embodiment. The operation—HTML form association table 161 is a table representing an association between an operation in the operation log and an HTML form and has, for each operation, four items: operation name, HTML form name, request requesting form, and request for response input. The screen controller 133 refers to the operation—HTML form association table 161 to thereby acquire an operation corresponding to screen data (HTML form name, argument name).

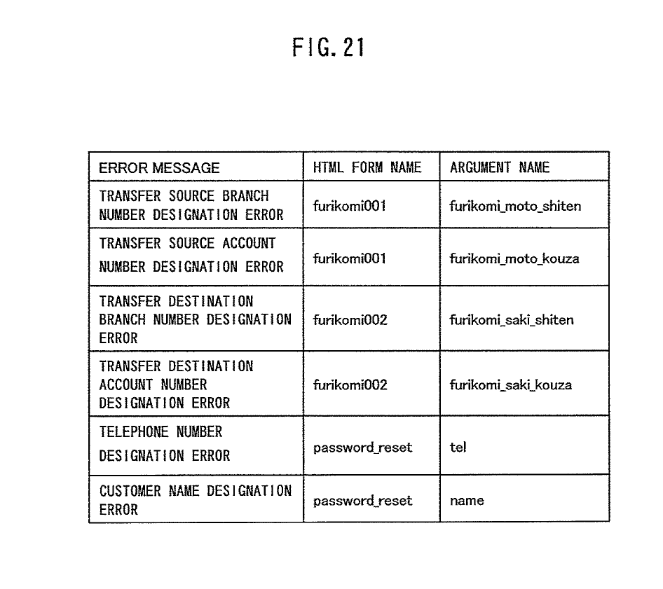

FIG. 21 is a table showing an example of the content of the error content-response input argument association table according to the present embodiment. The error content-response input argument association table 162 is a table representing an association between error content and a response input and the like and has, for each error, three items: error message, HTML form name, and argument name. The screen controller 133 refers to the error content-response input argument association table 162 to thereby acquire error content corresponding to screen data (HTML form name, argument name).

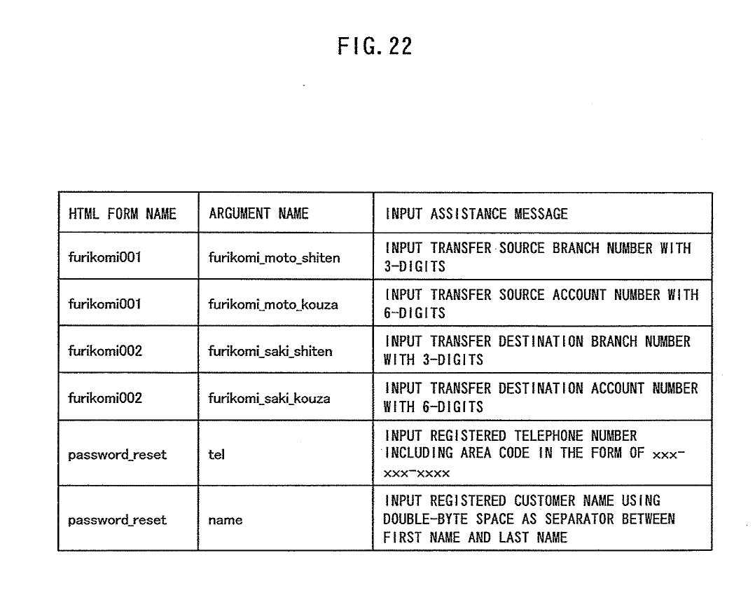

FIG. 22 is a table showing an example of the content of the response input assistance message table according to the present embodiment. The response input assistance message table 163 is a table storing an input assistance message (information about input contents) for assisting a user of the client 1 to make an adequate response input and has three items: HTML form name, argument name, and input assistance message. The screen controller 133 refers to the response input assistance message table 163 to thereby acquire an input assistance message corresponding to screen data (HTML form name, argument name).

According to the abovementioned screen control processing, a user of the screen reproduction apparatus 4 can easily change one screen to another based on the order of the screen displayed on the client 1. Further, by displaying an error log or screen additional information corresponding to the screen data, the user can confirm the content of an error or input assistance.

Reproduction of a screen of the client 1 that the screen reproduction apparatus 4 performs in the case where trouble is caused by the operation of a user of the client 1 will next be described using two concrete examples.

A first concrete example is a case where a user of the client 1 has input the account number of the transfer destination with one digit on a transfer destination designation screen although it needs to be input with 6-digits.

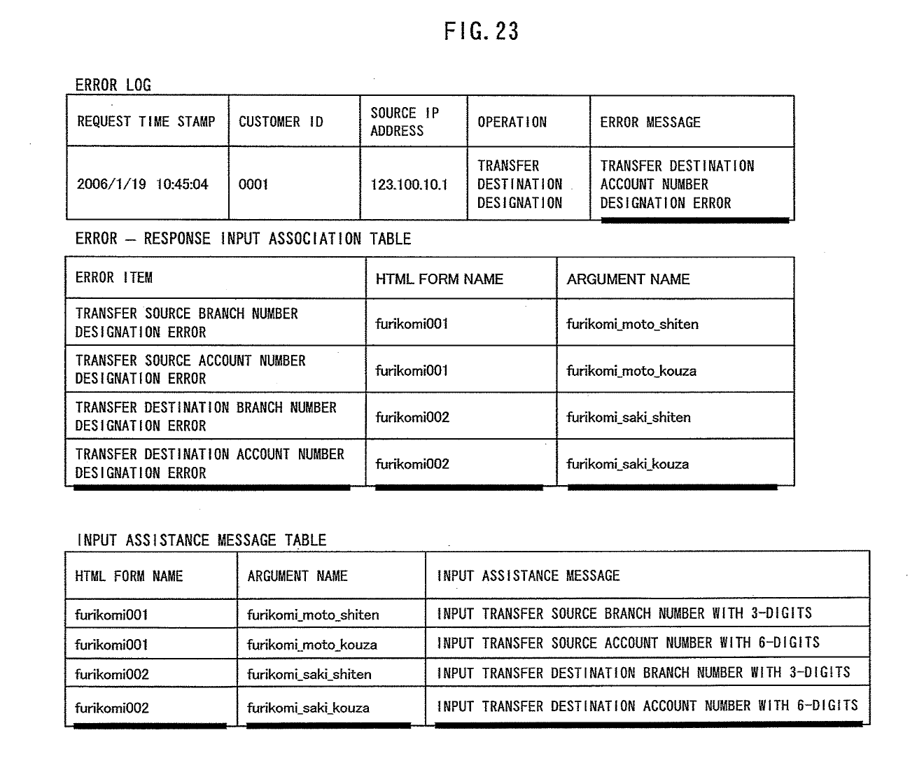

FIG. 23 is a view showing an example of information used for display of the first concrete example according to the present embodiment. In FIG. 23, the error log in the error log storage section 6, and error content-response input argument association table and input assistance message table in the screen additional information storage section 132 are shown. The parts indicated by thick underlines in FIG. 23 are information corresponding to the above error.

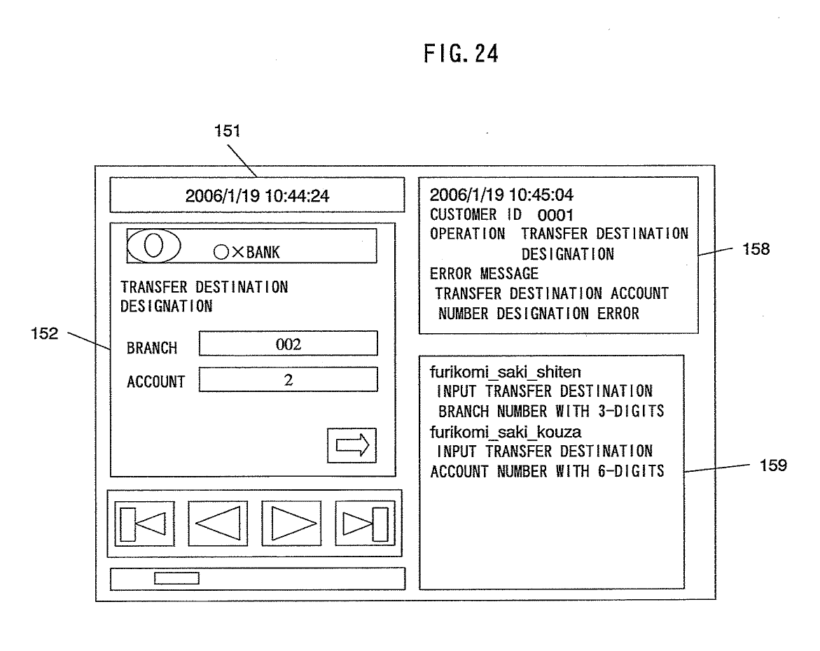

FIG. 24 is a view showing an example of a GUI display in the first concrete example according to the present embodiment. The screen controller 133 displays screen data in which a response input has been embedded in a screen corresponding to the error log on the screen data display area 152 according to the operation of a user of the screen reproduction apparatus 4 as well as displays a time stamp on the time stamp display area 151. Further, the screen controller 133 reads out error contents corresponding to an HTML form name and argument name of the displayed screen data from the error content-response input association table and displays them on the error log display area 158. Further, the screen controller 133 reads out an input assistance message corresponding to the HTML form name and argument name of the displayed screen data and displays them on the input assistance message display area 159.

A second concrete example is a case where a user of the client 1 needs to input a telephone number for reissue of password and he or she has input a telephone number with an incorrect form.

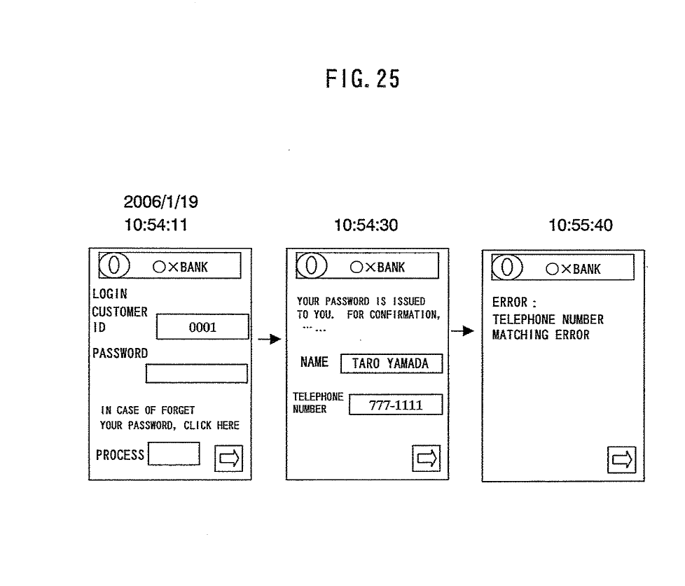

FIG. 25 is a view showing an example of screen data in the second concrete example according to the present embodiment. Firstly, a login screen, which is a first screen, is displayed on the client 1. If a user of the client 1 has forgotten his or her password and performs operation for reissue of password, a name/telephone number confirmation screen, which is a second screen, is displayed. If the user inputs a telephone number with an incorrect form, an error screen, which is a third screen, is displayed.

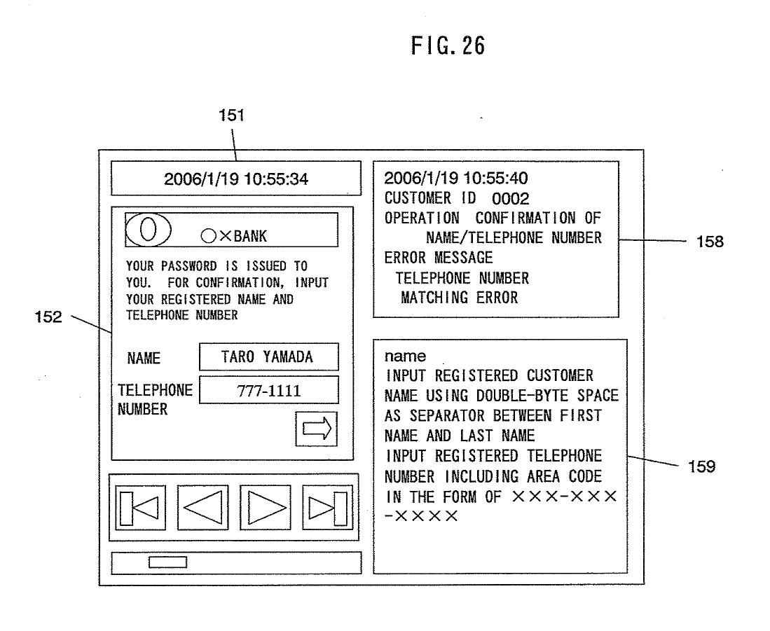

FIG. 26 is a view showing an example of a GUI display in the second concrete example according to the present embodiment. The screen controller 133 displays screen data in which a response input has been embedded in the form of a name/telephone number confirmation screen on the screen data display area 152 according to the operation of a user of the screen reproduction apparatus 4. Further, the screen controller 133 reads out error contents corresponding to an HTML form name and argument name of the displayed screen data from the error content-response input association table and displays them on the error log display area 158. Further, the screen controller 133 reads out an input assistance message corresponding to the HTML form name and argument name of the displayed screen data and displays them on the input assistance message display area 159.

The use of the screen reproduction apparatus 4 at a call center allows reproduction of a screen displayed on the client 1 in which an error has occurred as well as allows the screen to be freely changed in forward and backward directions.

As a result, it is possible to correctly grasp the content of user's inquiry issued from the client 1. Further, by displaying the reproduced screen as well as additional information corresponding to the reproduced screen, it is possible for the call center to take adequate action for the user's inquiry issued from the client 1.

### Second Embodiment

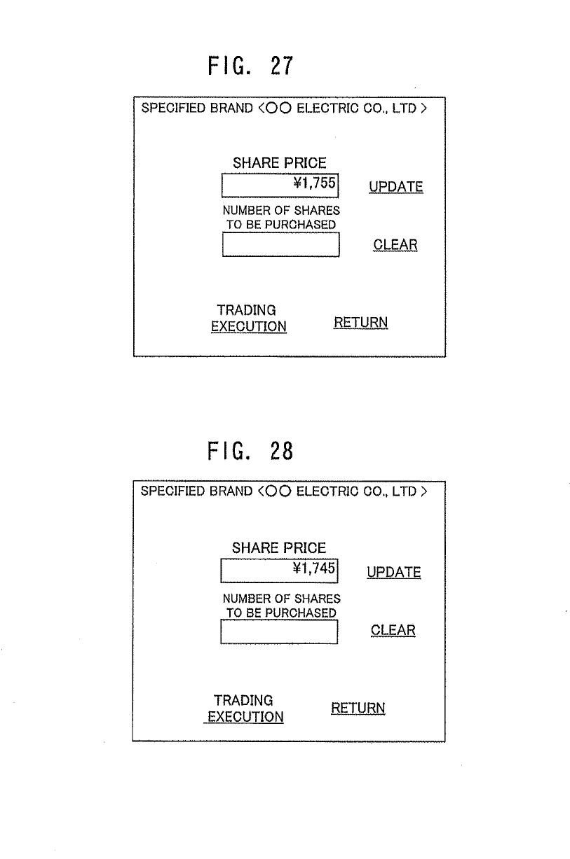

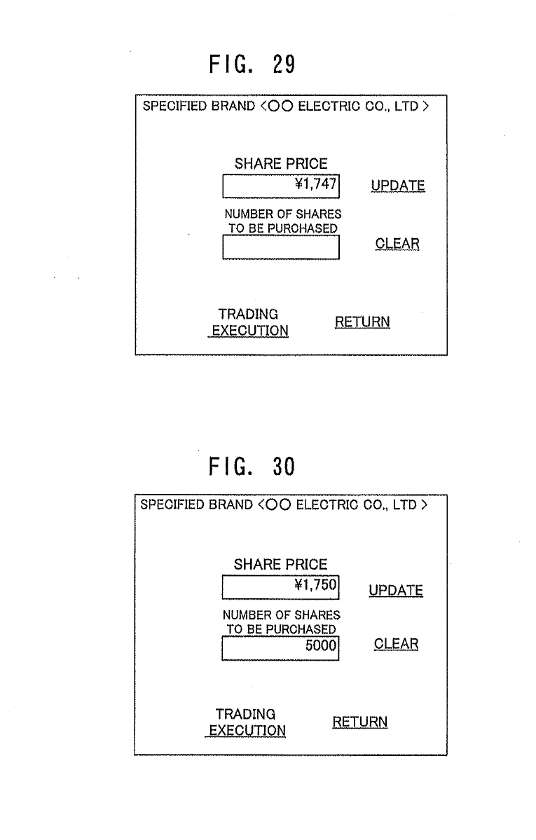

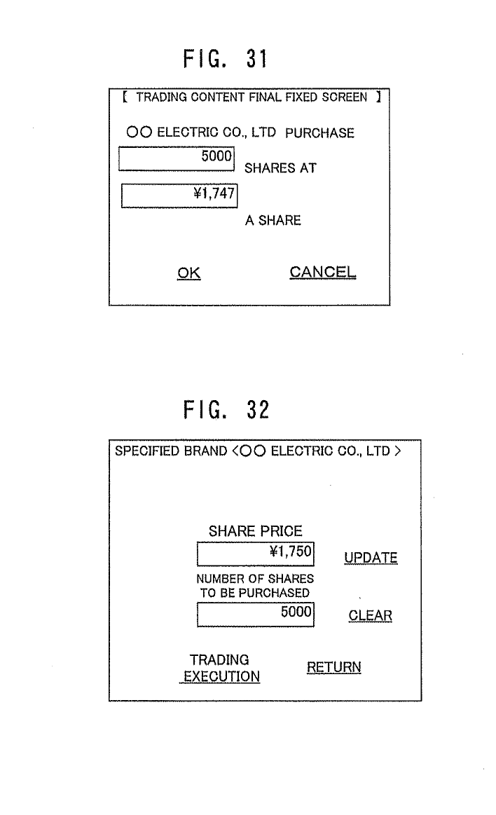

Taking a share trading application as an example, user operation to a client will be described. FIG. 27 is a view showing a first state of a share purchase screen displayed on the client. FIG. 28 is a view showing a second state of the share purchase screen displayed on the client. FIG. 29 is a view showing a third state of the share purchase screen displayed on the client. FIG. 30 is a view showing a fourth state of the share purchase screen displayed on the client. FIG. 31 is a view showing a first state of a trading decision screen displayed on the client. FIG. 32 is a view showing a fifth state of the share purchase screen displayed on the client.

Displayed on the share trading screen are a share price display field, an update button, a share purchase number input field for inputting the number of shares to be purchased, a clear button, a trading execution button, and a return button. Firstly, login authentication is performed on the client, a brand of shares to be purchased is specified, and the first state of the share purchase screen is displayed. When a user depresses the update button in the first state of the share purchase screen, the share purchase screen is shifted from the first state to second state. The second state of the share purchase screen is a screen on which the share price in the share price display filed has been updated from the first state of the share purchase screen as a result of client's acquisition of the current share price from a Web server. Subsequently, when the user depresses the update button in the second state of the share purchase screen, the share purchase screen is shifted from the second state to third state. The third state of the share purchase screen is a screen on which the share price in the share price display filed has been updated from the second state of the share purchase screen as a result of client's acquisition of the current share price from the Web server.

Subsequently, when the user inputs the number of shares to be purchased in the share purchase number input field in the third state of the share purchase screen, the share purchase screen is shifted from the third state to fourth state. The fourth state of the share purchase screen is a screen obtained by inputting the number of shares to be purchased in the share purchase number input field of the share purchase screen in the third state. Subsequently, when the user depresses the trading execution button in the fourth state of the share purchase screen, the share purchase screen is shifted from the fourth state of the share purchase screen to first state of the trading decision screen.

Displayed in the first state of the trading decision screen are share price and number of shares to be purchased in the fourth state of the share purchase screen as well as an OK button and a cancel button. When the user depresses the cancel button in the first state of the trading decision screen, the first state of the trading decision screen is shifted to the fifth state of the share purchase screen. The fifth state of the share purchase screen is the same as the fourth state of the share purchase screen. Then, the user calls a call center in order to ask an operational question.

In the case where the call center is provided with the screen reproduction apparatus according to the first embodiment, an operator (operator of the call center) needs to track the screen transition while changing the screen reproduced by the screen reproduction apparatus 4 from one screen to the next in order to respond to the inquiry.

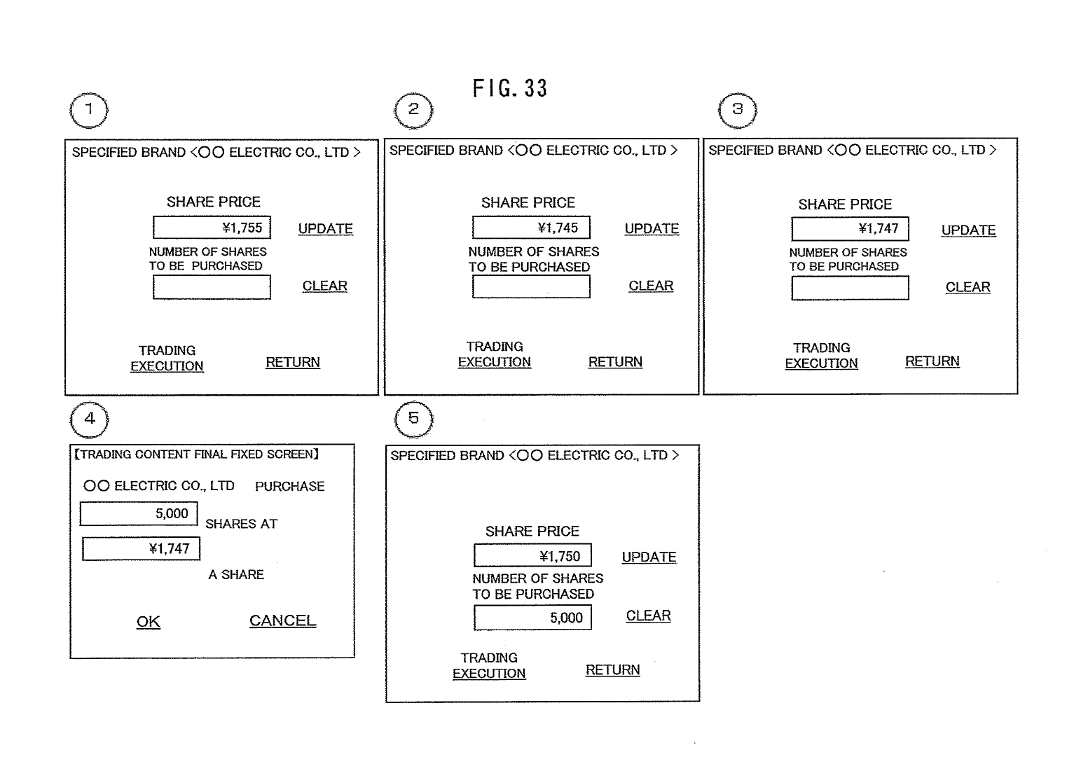

The screen reproduction apparatus according to the first embodiment may be configured to display a plurality of reproduced screens using a thumbnail view. FIG. 33 is a view showing an example of the thumbnail view displayed on the screen reproduction apparatus according to the first embodiment. On the thumbnail view, the first, second, third and fourth states of the share purchase screens, first state of the trading decision screen, and fifth state of the share purchase screen are arranged in the order mentioned. However, in the case where the abovementioned operational screens are displayed using the thumbnail view, it is difficult for the operator to confirm the operation content in perfect detail. In particular, it is hard to grasp which button has been depressed for screen transition.

In the present embodiment, a screen reproduction apparatus for allowing the operator to grasp the screen transition in the client in an easier manner will be described.

A configuration of a screen reproduction apparatus according to the present embodiment will first be described.

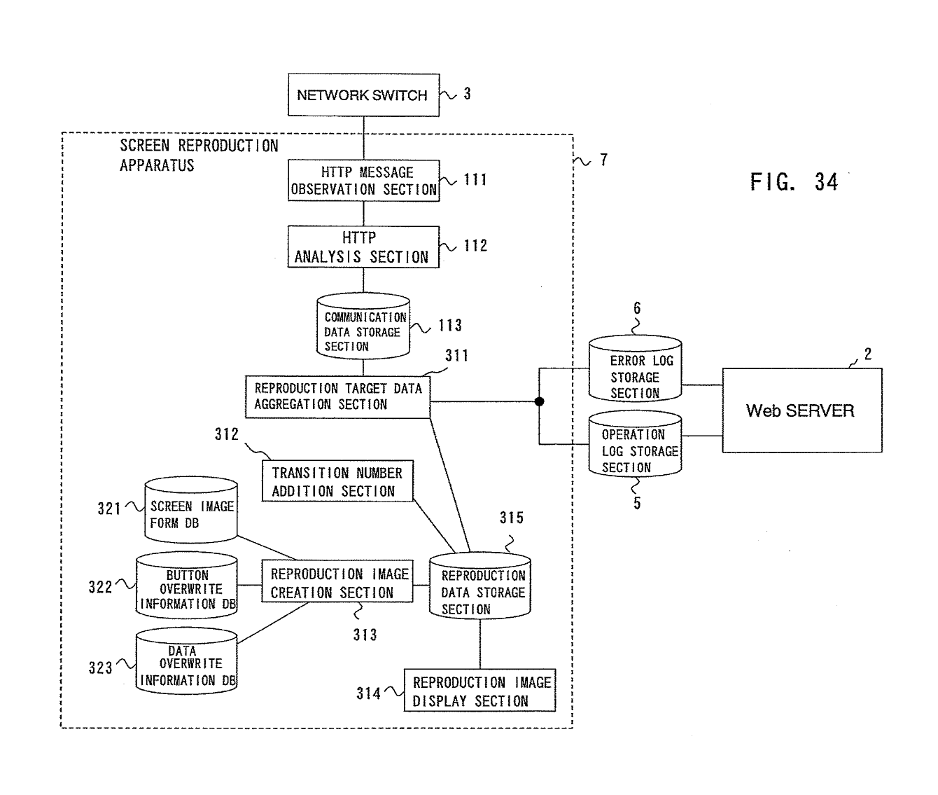

FIG. 34 is a block diagram showing an example of a configuration of the screen reproduction apparatus according to the present embodiment. In FIG. 34, the same reference numerals denote the same or corresponding parts as in FIG. 2, and the descriptions thereof will be omitted. Comparing with FIG. 2, a screen reproduction apparatus 7 is used in place of the screen reproduction apparatus 4. Further, comparing with the screen reproduction apparatus 4, the screen reproduction apparatus 7 newly includes a reproduction target data aggregation section 311, a transition number addition section 312, a reproduction image creation section 313, a reproduction image display section 314, a reproduction data storage section 315, a screen image form DB (Database) 321, a button overwrite information DB 322, and a data overwrite information DB 323, while does not require the communication data extraction section 121, screen data generation section 122, screen component file storage section 123, screen data storage section 124, screen additional information storage section 132, screen controller 133, and screen display section 134.

The reproduction data storage section 315 stores a reproduction target record extraction table, a reproduction target aggregation table, a data transition management table A, a data transition management table B, and an overwrite reproduction screen image data.

Operation of the screen reproduction apparatus according to the present embodiment will next be described.

The screen reproduction apparatus according to the present embodiment uses the HTTP message observation section 111 and HTTP analysis section 112 to perform communication data acquisition processing as in the case of the first embodiment and, after that, performs the following screen reproduction processing.

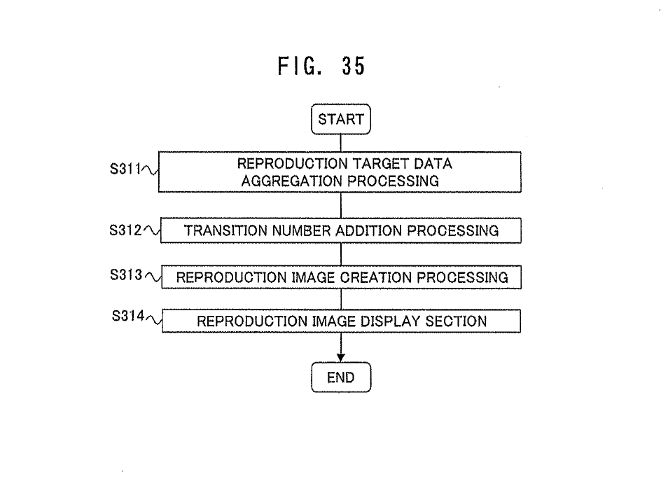

FIG. 35 is a flowchart showing an example of operation of the screen reproduction processing according to the present embodiment. The reproduction target data aggregation section 311 performs reproduction target data aggregation processing to aggregate data to be reproduced from information stored in the communication data storage section 113 (S311). Then, the transition number addition section 312 performs transition number addition processing to add numbers concerning the screen transition to the data to be reproduced (S312). Then, the reproduction image creation section 313 performs reproduction image creation processing to create a reproduction image (S313). Then, the reproduction image display section 314 performs reproduction image display processing to display the created reproduction image (S314), and this flow ends. Hereinafter, for the sake of simplification, it is assumed, in the screen to be handled by the screen reproduction apparatus, that one screen corresponds to one form and the form is a simple HTML including no image.

Details of the reproduction target data aggregation processing will next be described.

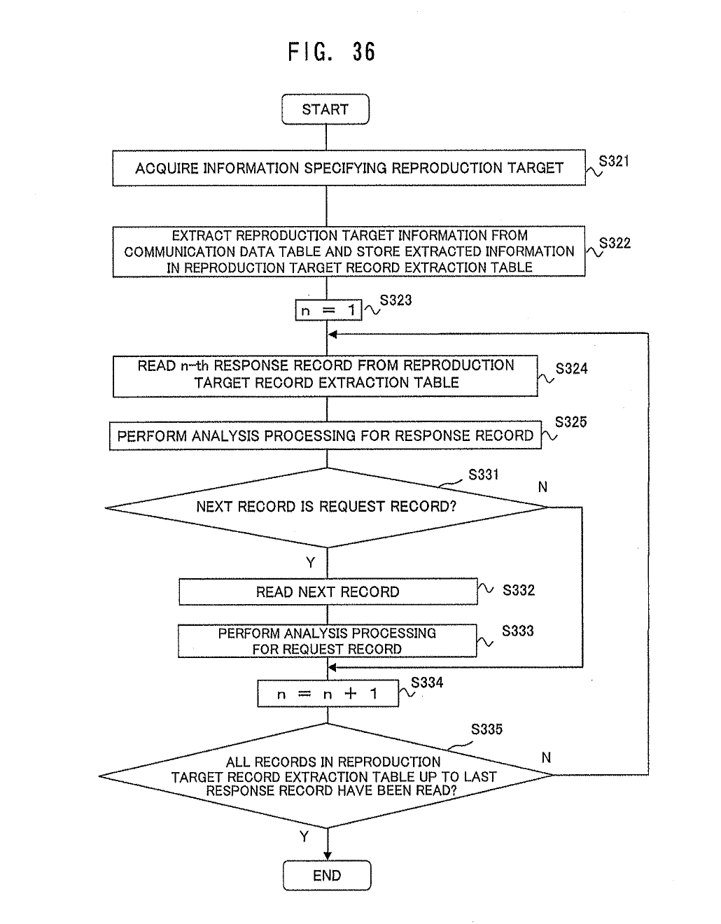

FIG. 36 is a flowchart showing an example of operation of the reproduction target data aggregation processing according to the present embodiment. The reproduction target data aggregation section 311 acquires information that specifies a reproduction target (S321). The reproduction target includes a reproduction target customer who has conducted any operations to be reproduced and a reproduction target time zone in which the operations to be reproduced have been conducted. In the present embodiment, a pair of an IP address and connection port serves as information for specifying the reproduction target customer. The reproduction target data aggregation section 311 acquires the above information based on input operation performed by an operator. The operator can acquire the above information from information stored in the error log storage section 6 or communication data storage section 113.

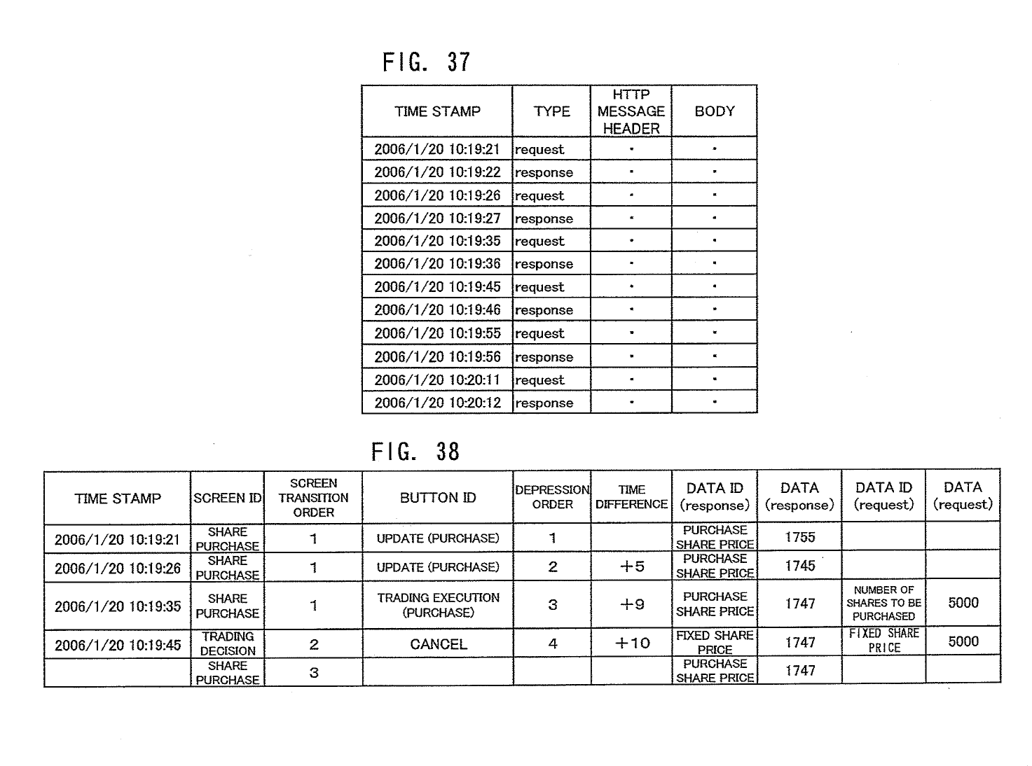

Then, the reproduction target data aggregation section 311 extracts records each having a time stamp falling within a reproduction target time zone and having a specified pair of an IP address and connection port from the communication data table stored in the communication data storage section 113 in the time stamp order and stores the extracted records in a reproduction target record extraction table of the reproduction data storage section 315 (S322). The record having a specified pair of an IP address and connection port is a record having the pair as “transmission destination IP address: connection port” or “transmission source IP address: connection port”. FIG. 37 is a table showing an example of content of the reproduction target record extraction table according to the present embodiment. Out of items stored in the communication data table, four items of “time stamp”, “type”, “HTTP message header”, and “body” are stored in the reproduction target record extraction table.

Then, the reproduction target data aggregation section 311 initializes a variable n indicating the response record number in the reproduction target record extraction table to 1 (S323). The reproduction target data aggregation section 311 then reads an n-th response record from the reproduction target record extraction table (S324) and performs response analysis processing to analyze the read response record (S325).

Then, the reproduction target data aggregation section 311 determines whether the next record in the reproduction target record extraction table is a request record. In the case where the next record is not a request record (N in S331), the flow shifts to step S334. In the case where the next record is a request record (Y in S331), the reproduction target data aggregation section 311 reads the next record, i.e., a request record (S332) and performs request record analysis processing to analyze the request record (S333). The flow then shifts to step S334, where the reproduction target data aggregation section 311 increments the value of n by 1

(S334) and determines whether it has read all records in the reproduction target record extraction table up to the last response record. In the case where the reproduction target data aggregation section 311 has not read up to the last response record (N in S335), the flow shifts to S324. In the case where the reproduction target data aggregation section 311 has read up to the last response record (Y in S335), this flow is ended.

A part of the items in the reproduction target aggregation table of the reproduction data storage section 315 has been set by the above response record analysis processing and request record analysis processing. FIG. 38 is a table showing an example of the content of the reproduction target aggregation table according to the present embodiment. The reproduction target aggregation table stores the following items: “time stamp”, “screen ID”, “screen transition order”, “button ID”, “depression order”, “time difference”, “data ID (response)”, “data (response)”, “data ID (request)”, and “data (request)”. Although only one data is included in each of one request and one response in the present embodiment, a plurality of data may be included in each of one request and one response.

Details of the response record analysis processing will next be described.

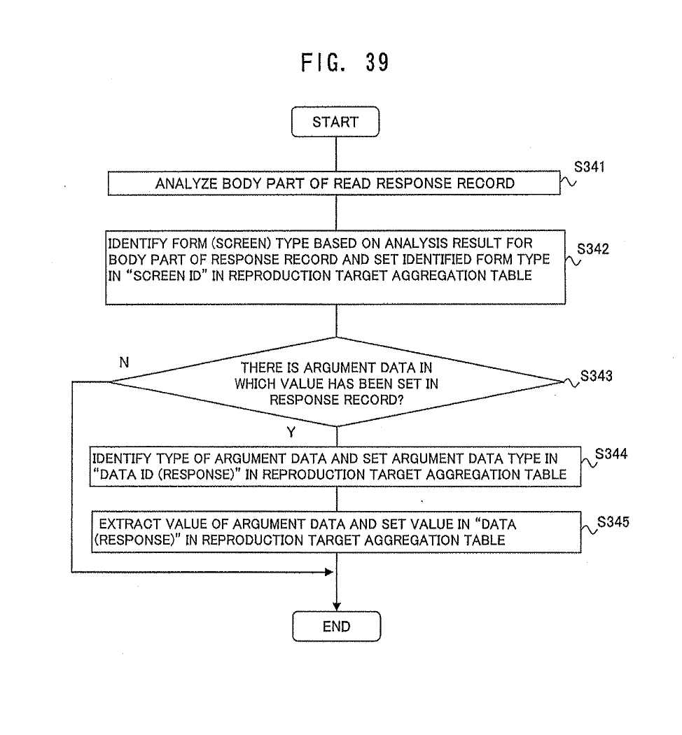

FIG. 39 is a flowchart showing an example of operation of the response record analysis processing according to the present embodiment. The reproduction target data aggregation section 311 analyzes the body part of a read response record (S341). Then, reproduction target data aggregation section 311 identifies a form (screen) type from a result of the analysis for the body part and sets the form type in “screen ID” in the reproduction target aggregation table (S342). The reproduction target data aggregation section 311 then determines there is argument data in which a value has been set in the response record (S343). In the case where the argument data in which a value has been set does not exist (N in S343), this flow is ended. In the case where the argument data in which a value has been set exists (Y in S343), the reproduction target data aggregation section 311 identifies the type of the argument data and sets the argument data type in “data ID (response)” in the reproduction target aggregation table (S344). Subsequently, the reproduction target data aggregation section 311 extracts the value of the argument data and sets the value in “data (response)” in the reproduction target aggregation table (S345). Then, this flow is ended.

Details of the request record analysis processing will next be described.

FIG. 40 is a flowchart showing an example of operation of the request record analysis processing according to the present embodiment. The reproduction target data aggregation section 311 sets a time stamp of a read request record in “time stamp” of the reproduction target aggregation table (S352).

Then, the reproduction target data aggregation section 311 determines whether n is greater than 1. In the case where n is not greater than 1 (N in S353), the flow shifts to step S355. In the case where n is greater than 1 (Y in S353), the reproduction target data aggregation section 311 calculates a difference between the time stamp of the request record and that of a previous record in the reproduction target aggregation table and sets the difference in “time difference” of the reproduction target aggregation table as a signed value (S354). The reproduction target data aggregation section 311 then analyzes the body part of the read request record (S355). The reproduction target data aggregation section 311 then identifies the type of a clicked button (including an operation of clicking a link or the like) based on the analysis result and sets the button type in “button ID” in the reproduction target aggregation table (S356).

Then, reproduction target data aggregation section 311 determines whether there is argument data in which a value has been set in the request record (S357). In the case where the argument data in which a value has been set does not exist (N in S357), this flow is ended. In the case where the argument data in which a value has been set exists (Y in S357), the reproduction target data aggregation section 311 identifies the type of the argument data and sets the argument data type in “data ID (request)” in the reproduction target aggregation table (S358). Subsequently, the reproduction target data aggregation section 311 extracts the value of the argument data and sets the value in “data (request)” in the reproduction target aggregation table (S359). Then, this flow is ended.

According to the above-described reproduction target aggregation processing, a series of operations performed by the user which are specified as data to be reproduced can be extracted.

Details of the transition number addition processing will next be described.

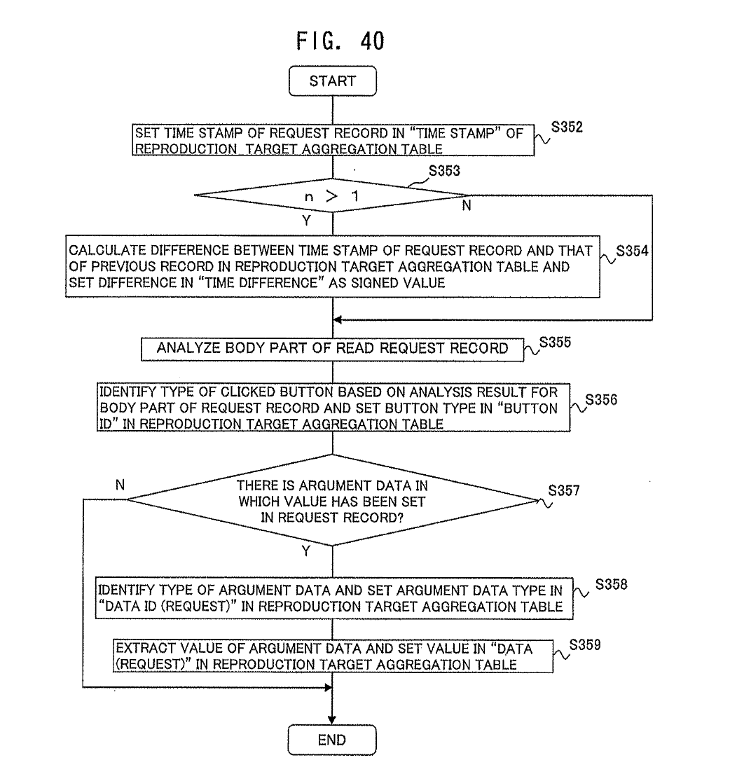

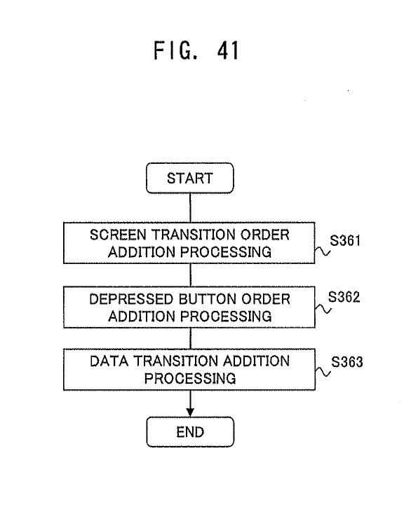

FIG. 41 is a flowchart showing an example of operation of the transition number addition processing according to the present embodiment. The transition number addition section 312 performs screen transition order addition processing to set information concerning the order of screen transition in the reproduction target aggregation table (S361), performs depressed button order addition processing to set information concerning the order of depressed buttons in the reproduction target aggregation table (S362), and performs data transition addition processing to set information concerning data transition in the reproduction target aggregation table (S363), and this flow is ended.

Details of the screen transition order addition processing will next be described.

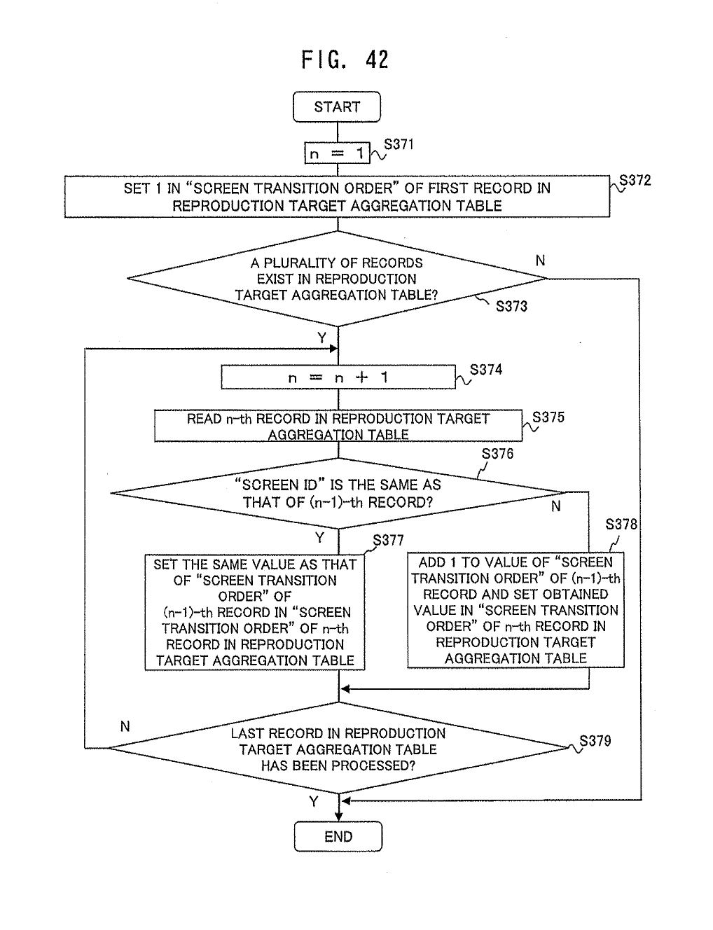

FIG. 42 is a flowchart showing an example of operation of the screen transition order addition processing according to the present embodiment. The transition number addition section 312 initializes a variable n to 1 indicating the record number in the reproduction target aggregation table (S371) and sets 1 in “screen transition order” of the first record in the reproduction target aggregation table (S372). The transition number addition section 312 then determines a plurality of records exist in the reproduction target aggregation table. In the case where a plurality of records do not exist (N in S373), this flow is ended. In the case where a plurality of records exist (Y in S373), the flow shifts to the next step.

The transition number addition section 312 increments n by 1 (S374) and reads an n-th record in the reproduction target aggregation table (S375). The transition number addition section 312 then determines whether “screen ID” of the record is the same as that of an (n−1)-th record (S376). When “screen IDs” are the same (Y in S376), the transition number addition section 312 sets the same value as that of “screen transition order” of the (n−1)-th record in the “screen transition order” of the n-th record in the reproduction target aggregation table (S377). In the case where “screen IDs” are not the same (N in S376), the transition number addition section 312 adds 1 to the value of “screen transition order” of the (n−1)-th record and sets the obtained value in the “screen transition order” of the n-th record in the reproduction target aggregation table (S378), and the flow shifts to S379. The transition number addition section 312 then determines whether it has processed the last record in the reproduction target aggregation table. In the case where the last record has not been processed (N in S379), the flow returns to S374. In the case where the last record has been processed (Y in S379), this flow is ended.

Details of the depressed button order addition processing will next be described.

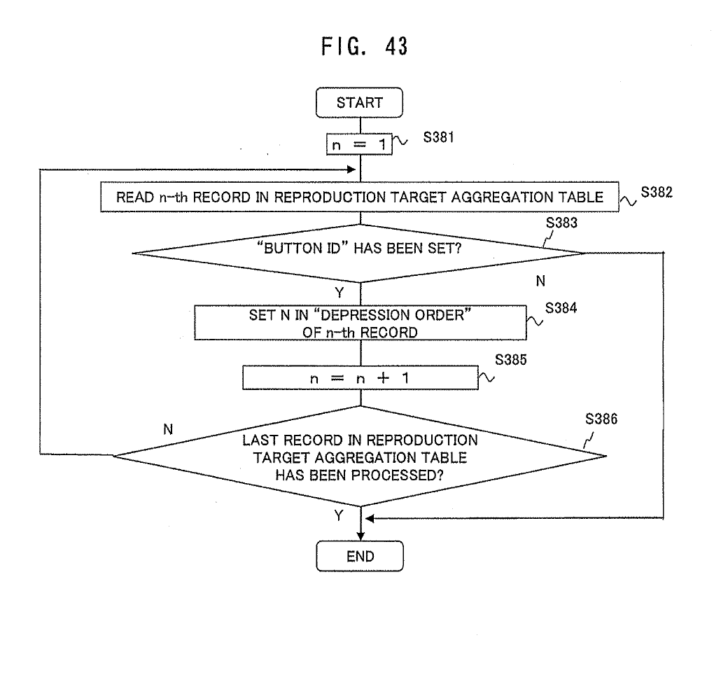

FIG. 43 is a flowchart showing an example of operation of the depressed button order addition processing according to the present embodiment. The transition number addition section 312 initializes the variable n to 1 indicating the record number in the reproduction target aggregation table (S381) and reads an n-th record in the reproduction target aggregation table (S382). The transition number addition section 312 then determines whether “button ID” has been set in the read record. In the case where “button ID” has not been set (N in S383), this flow is ended. In the case where “button ID” has been set (Y in S383), the transition number addition section 312 sets n in “depression order” of the n-th record (S384) and increments n by 1 (S385). The transition number addition section 312 then determines whether it has processed the last record in the reproduction target aggregation table. In the case where the last record has not been processed (N in S386), the flow returns to S382. In the case where the last record has been processed (Y in S386), this flow is ended.

Although the description has been made in the case where the depression of the button triggers the screen transition in the present embodiment, another factor may trigger the screen transition.

Details of the data transition addition processing will next be described.

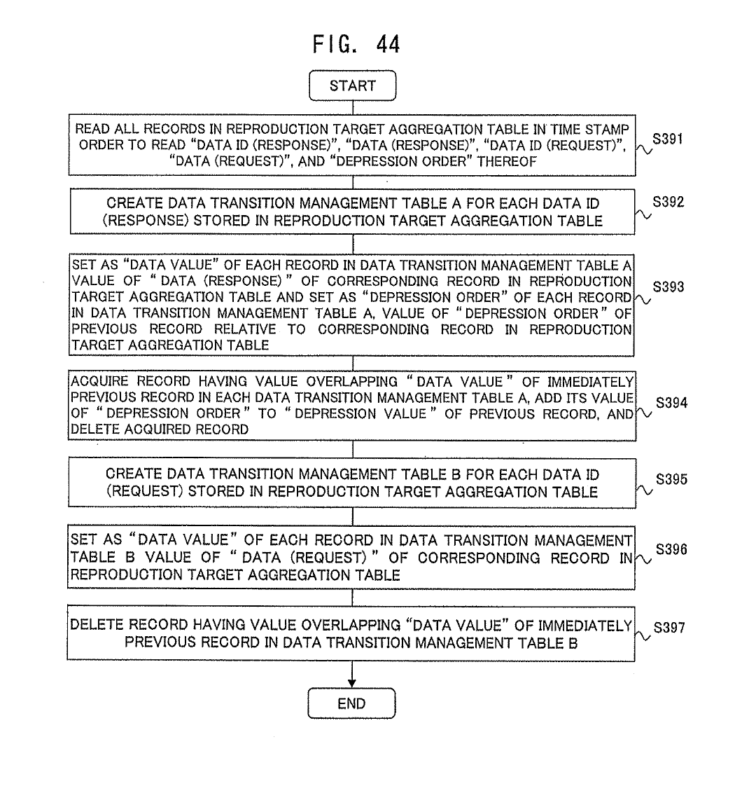

FIG. 44 is a flowchart showing an example of operation of the data transition addition processing according to the present embodiment. The transition number addition section 312 reads all records in the reproduction target aggregation table in the ascending order of the time stamp to read “data ID (response)”, “data (response)”, “data ID (request)”, “data (request)”, and “depression order” thereof (S391). The transition number addition section 312 creates a data transition management table A for each data ID (response) stored in the reproduction target aggregation table and stores it in the reproduction data storage section 315 (S392).

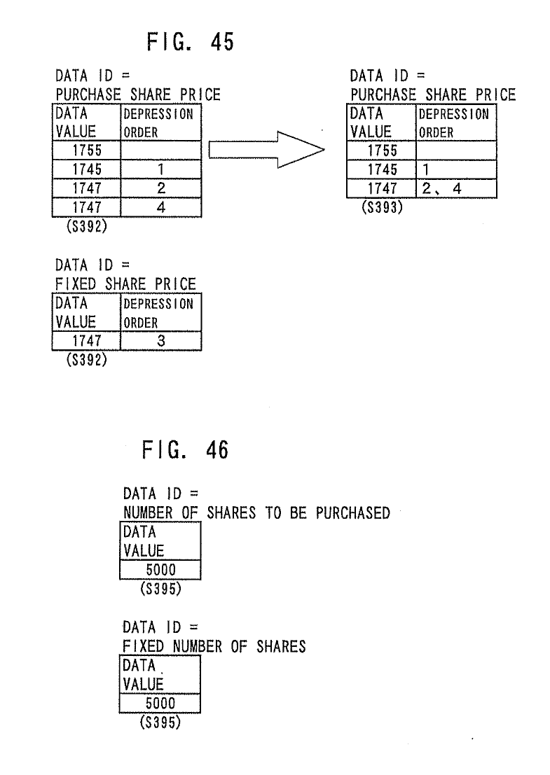

FIG. 45 is a view showing an example of the content of the data transition management table A according to the present embodiment. As described above, the response data transition management table A is created for each data ID (response). Since data ID (response) has two values (purchase share price, fixed share price) in this case, two data transition management tables A are created. Each of the data transition management table A has the items of “data value” and “depression order”. “Data value” in the data transition management table A corresponds to “data (response)” in the reproduction target aggregation table, and “depression order” corresponds to “depression order” in the reproduction target aggregation table.

Then, the transition number addition section 312 sets, as “data value” of each record in the data transition management table A, the value of “data (response)” of the corresponding record in the reproduction target aggregation table and sets, as “depression order” of each record in the data transition management table A, the value of “depression order” of the previous record relative to the corresponding record in the reproduction target aggregation table (S393).

Then, the transition number addition section 312 acquires a record having a value overlapping “data value” of the immediately previous record in each data transition management table A, adds its value of “depression order” to “depression value” of the previous record, and deletes the acquired record (S394).

Then, the transition number addition section 312 creates a data transition management table B for each data ID (request) stored in the reproduction target aggregation table and stores it in the reproduction data storage section 315 (S395).

FIG. 46 is a view showing an example of the content of the data transition management table B according to the present embodiment. Since data ID (request) has two values (purchase share price, fixed share price) in this case, two data transition management table B are created. Each data transition management table B has an item of “data value”. “Data value” in the data transition management table B corresponds to “data (request)” in the reproduction target aggregation table.

Then, the transition number addition section 312 sets, as “data value” of each record in the data transition management table B, the value of “data (request)” of the corresponding record in the reproduction target aggregation table (S396).

Then, the transition number addition section 312 deletes a record having a value overlapping “data value” of the immediately previous record in the data transition management table B (S397), and this flow is ended.

According to the above-described transition number addition processing, the order of the screen transition in a series of operations to be reproduced and order of the operations can be extracted.

Although “data value” and “depression order” are set in the data transition management table A of each “data ID (response)” since the value of “data (response)” is changed in the present invention, “data value” and “depression order” may be set in the data transition management table B of each “data ID (request)” in the case where the value of “data (request)” is changed.

Details of the reproduction image creation processing will next be described.

The screen image form DB 321, button overwrite information DB 322, and data overwrite information DB 323, which are information for use in the reproduction image creation processing, are previously created and stored in a storage unit.

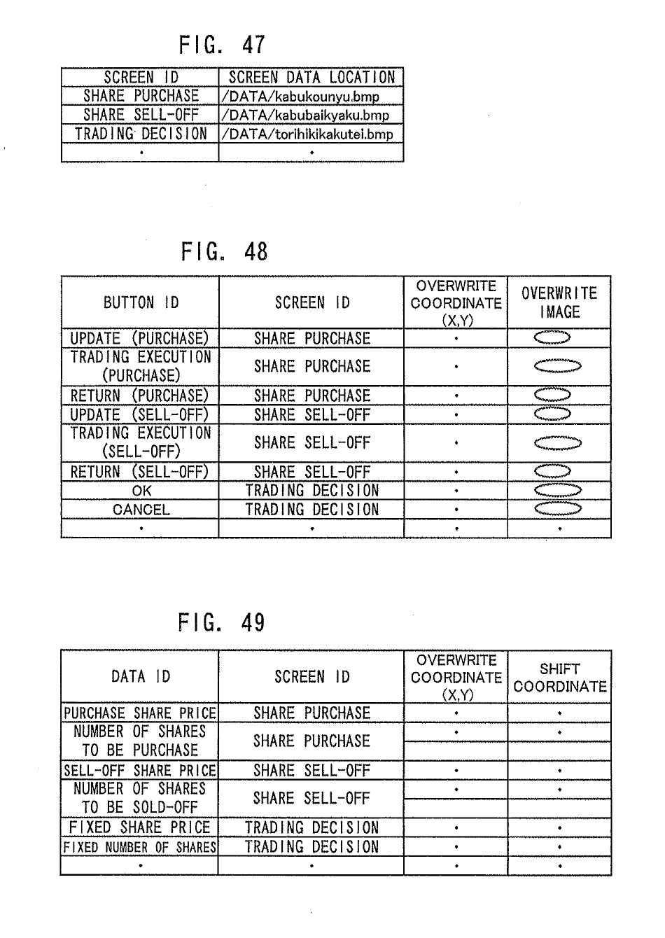

FIG. 47 is a table showing an example of the content of the screen image form DB according to the present embodiment. The screen image form DB 321 has two items of “screen ID” and “image data location”. “Image ID” in the screen image form DB 321 corresponds to “screen ID” in the reproduction target aggregation table. “Image data location” indicates the path of screen image form data. The screen image form data, which is an image of a screen obtained when an HTML form corresponding to “image ID” is displayed in a predetermined screen size, is previously created in a state where it includes no value and stored in the path specified by the value in “image data location”.

FIG. 48 is a table showing an example of the content of the button overwrite information DB according to the present embodiment. The button overwrite information DB 322 has four items of “button ID”, “screen ID”, “overwrite coordinate”, and “overwrite image”. “Button ID” and “screen ID” in the button overwrite information DB 322 correspond respectively to “button ID” and “screen ID” in the reproduction target aggregation table. The overwrite coordinate is an X-Y coordinate representing the position of a button in the case where an HTML form corresponding to “screen ID” is displayed in a predetermined image size. The overwrite image is an image for emphasizing the button position.

FIG. 49 is a table showing an example of the content of the data overwrite information DB according to the present embodiment. The data overwrite information DB 323 has four items of “data ID”, “screen ID”, “overwrite coordinate”, and “shift coordinate”. “Data ID” in the data overwrite information DB 323 corresponds to “data ID (response)” or “data ID (request)” in the reproduction target aggregation table. “Screen ID” in the data overwrite information DB 323 corresponds to “screen ID” in the reproduction target aggregation table. “Overwrite coordinate” is a coordinate (X, Y) representing the position of data in the case where an HTML form corresponding to “screen ID” is displayed in a predetermined image size. “Shift coordinate” is a unit of coordinate (X, Y) for shifting the position of data to be overwritten.

Before the reproduction image creation processing, the reproduction image creation section 313 may create an image in which an HTML form corresponding to “screen ID” is displayed based on previously set screen size to thereby create the screen image form data. The reproduction image creation section 313 may calculate the overwrite coordinate based on previously set screen size. Further, the reproduction image creation section 313 may calculate the overwrite coordinate and shift coordinate based on previously set screen size.

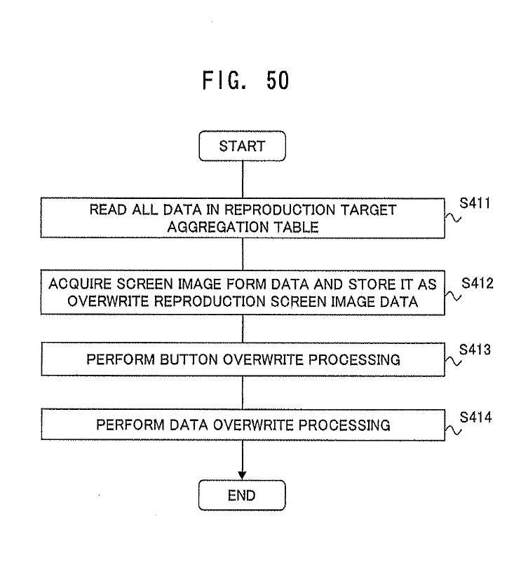

FIG. 50 is a flowchart showing an example of operation of the reproduction image creation processing according to the present embodiment. The reproduction image creation section 313 reads all data in the reproduction target aggregation table (S411). The reproduction image creation section 313 then acquires screen image form data corresponding to each “screen ID” of the reproduction target aggregation table based on the screen image form DB 321 and stores the acquired screen image form data in the reproduction data storage section 315 as overwrite reproduction screen image data corresponding to each “screen ID” (S412). More specifically, at this time, the reproduction image creation section 313 first acquires “image data location” corresponding to “screen ID” in the screen image form DB 321 and then acquires the screen image form data based on the acquired “image data location”.

Then, the reproduction image creation section 313 acquires all values of “button ID” in the reproduction target aggregation table and performs button overwrite processing to overwrite an image on the overwrite reproduction screen image data based on the button overwrite information DB 322 (S413). At this time, the reproduction image creation section 313 refers to the button overwrite information DB 322 using “button ID” as a key to acquire “overwrite coordinate” and “overwrite image” and overwrites an overwrite image on the position specified by “overwrite coordinate” on the overwrite reproduction screen image data.

Then, reproduction image creation section 313 reads “button ID”, “screen ID”, “depression order”, and “time difference” of all the records in each of which a value of “depression order” has been set in the reproduction target aggregation table and refers the button overwrite information DB 322 using “button ID” as a key to acquire “overwrite coordinate”. Subsequently, the reproduction image creation section 313 performs data overwrite processing to overwrite, as images, values of “depression order” and “time difference” on the vicinity of the position of “overwrite coordinate” on the overwrite reproduction screen image data (S414), and this flow is ended.

Details of the data overwrite processing will next be described.

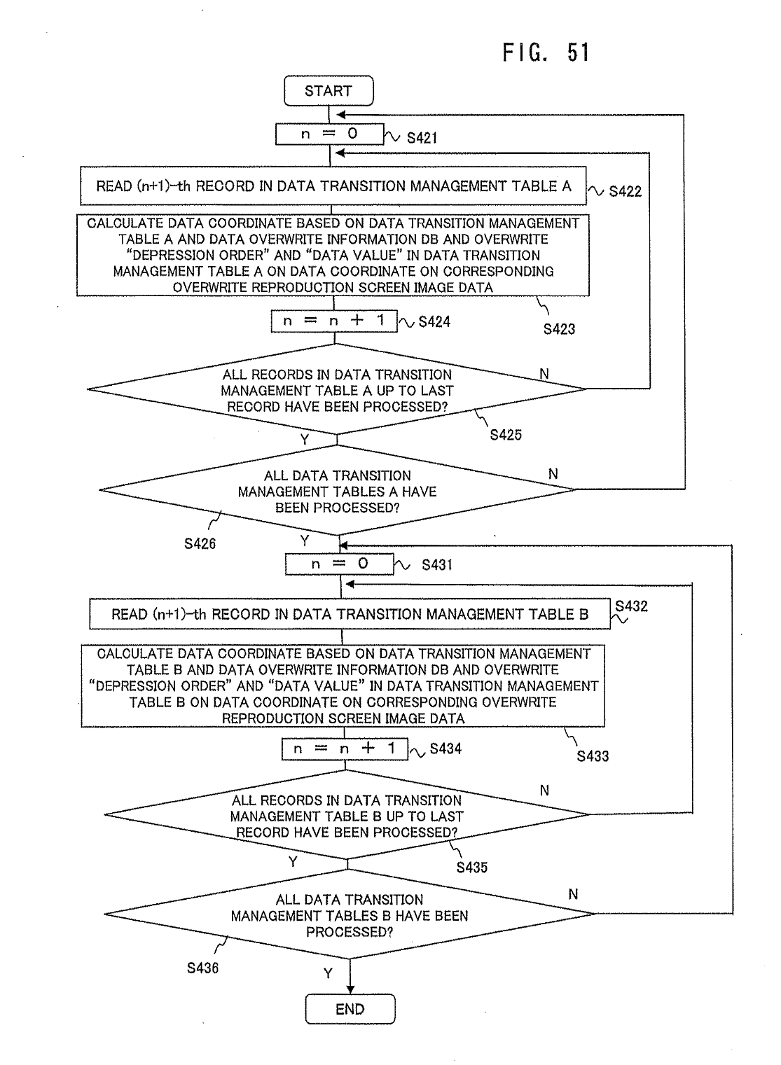

FIG. 51 is a flowchart showing an example of operation of the data overwrite processing according to the present embodiment. The reproduction image creation section 313 initialize a variable n indicating the record number in the data transition management table A to 0 (S421). Then, the reproduction image creation section 313 reads an (n+1)-th record in the data transition management table A (S422). The reproduction image creation section 313 calculates a data coordinate based on the data transition management table A and data overwrite information DB 323 and overwrites “depression number” and “data value” in the data transition management table A on the data coordinate on the corresponding overwrite reproduction screen image data (S423). The data coordinate is a coordinate of “depression order” and “data value” arranged on the overwrite reproduction screen image data. At this time, the reproduction image creation section 313 acquires “overwrite coordinate” and “shift coordinate” in the data overwrite information DB 323 using “data ID” and “screen ID” in the data transition management table A as a key and sets (overwrite coordinate)+(shift coordinate)*n as the data coordinate.

The reproduction image creation section 313 increments n by 1 (S424) and determines whether it has processed all the records in the data transition management table A up to the last record. In the case where the last record has not been processed (N in S425), the flow returns to S422. In the case where the last record has been processed (Y in S425), this flow shifts to the next step. The reproduction image creation section 313 then determines whether it has processed all data transition management tables A. In the case where all data transition management tables A have not been processed (N in S426), the flow returns to step S421 where the reproduction image creation section 313 performs processing for the next data transition management table A. In the case where all data transition management tables A have been processed (Y in S426), the flow shifts to the next step.

Then, the reproduction image creation section 313 initializes a variable n to 0 indicating the record number in the data transition management table B (S431). The reproduction image creation section 313 then reads an (n+1)-th record in the data transition management table B (S432). The reproduction image creation section 313 calculates a data coordinate based on the data transition management table B and data overwrite information DB 323 and overwrites “depression order” and “data value” in the data transition management table B on the data coordinate on the corresponding overwrite reproduction screen image data (S433). At this time, the reproduction image creation section 313 acquires “overwrite coordinate” and “shift coordinate” in the data overwrite information DB 323 using “data ID” and “screen ID” in the data transition management table B as a key and sets (overwrite coordinate)+(shift coordinate)*n as the data coordinate.

The reproduction image creation section 313 increments n by 1 (S434) and determines whether it has processed all the records in the data transition management table B up to the last record. In the case where the last record has not been processed (N in S435), the flow returns to S432. In the case where the last record has been processed (Y in S435), this flow shifts to the next step. The reproduction image creation section 313 then determines whether it has processed all data transition management tables B. In the case where all data transition management tables B have not been processed (N in S436), the flow returns to step S431 where the reproduction image creation section 313 performs processing for the next data transition management table B. In the case where all data transition management tables B have been processed (Y in S436), this flow is ended.

According to the reproduction image creation processing, it is possible to create, with respect to a series of screen to be reproduced, a screen including the content and order of the operation performed on the respective screens and content and order of the displays shown on the respective screen. Further, in the case of, e.g., button click operation, a graphic image emphasizing the position at which the button has been clicked, order of operation, time difference between two successive operations, and the like are added to a form image, and in the case of operation involving input of values or display of values, a value, order of operations, time difference between two successive operations, and the like are added onto the vicinity of the position of the value displayed on a form image. This allows the operator to easily grasp a series of operations.

Details of the reproduction image display processing will next be described.

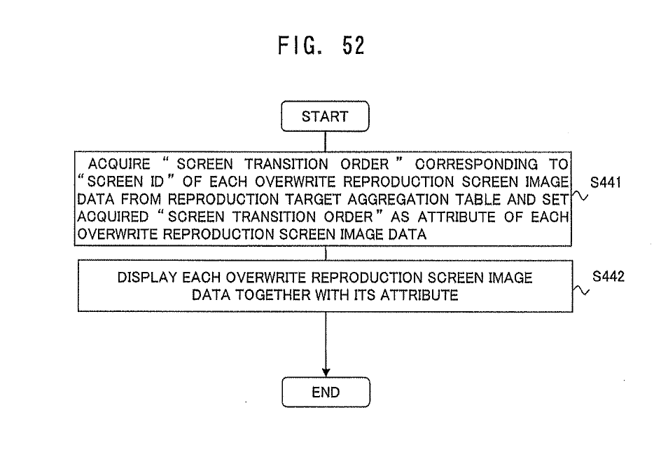

FIG. 52 is a flowchart showing an example of operation of the reproduction image display processing according to the present embodiment. The reproduction image display section 314 acquires “screen transition order” corresponding to “screen ID” of each overwrite reproduction screen image data from the reproduction target aggregation table and sets the acquired “screen transition order” as an attribute of each overwrite reproduction screen image data (S441). Then, the reproduction image display section 314 displays each overwrite reproduction screen image data together with its attribute as a reproduction screen (S442), and this flow is ended.

Examples of the reproduction screen displayed by the above reproduction image display processing will next be described.

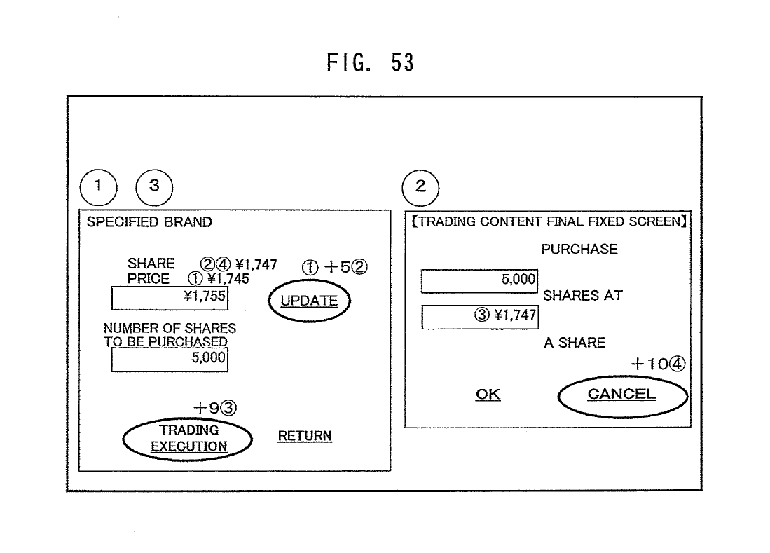

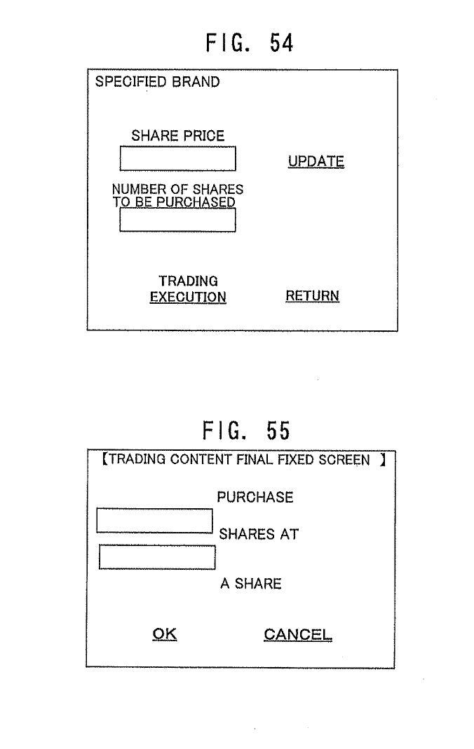

FIG. 53 is a view showing an example of the reproduction screen according to the present embodiment. Two overwrite reproduction screen image data are arranged side-by-side on the reproduction screen. The left side data, which is first overwrite reproduction screen image data, is created based on first screen image form data stored in the screen image form DB 321, and right side data, which is second overwrite reproduction screen image data, is created based on second screen image form data stored in the screen image form DB 321. FIG. 54 is a view showing an example of the first screen image form data according to the present embodiment. FIG. 55 is a view showing an example of the second screen image form data according to the present embodiment. “Screen ID” of the first screen image form data is “share purchase”, and “screen ID” of the second screen image form data is “trading decision”. These screen image form data are overwrite reproduction screen image data before being overwritten.

Through the button overwrite processing, overwrite images indicating buttons (“update” and “trading execution”) that have been depressed are overwritten on the data coordinate in the first overwrite reproduction screen image data, and an overwrite image indicating a button (“cancel”) that has been depressed is overwritten on the data coordinate in the second overwrite reproduction screen image data.

Further, through the data overwrite processing, overwrite images indicating values of data (“purchase share price” and “number of shares to be purchased”) that have been input or displayed are overwritten on the data coordinate in the first overwrite reproduction screen image data, and a value of data (“fixed share price” and “fixed number of shares to be purchased”) that have been input are overwritten on the data coordinate in the second overwrite production screen image data. Further, through the data overwrite processing, values indicating the time difference in the button depression and button depression order (1, 2, 3) are overwritten on the data coordinates in the first and second overwrite reproduction screen image data.

Although two overwrite reproduction screen image data are displayed in this example, it is also possible to create the screen image form data so as to allow them to have easily viewable sizes and to determine the number of overwrite reproduction screen image data to be displayed on the reproduction screen based on the controlled screen sizes. Alternatively, it is possible to determine the screen size based on the number of overwrite reproduction screen image data to be displayed on the reproduction screen and to create the screen image form DB 321, button overwrite information DB 322, and data overwrite information DB 323.

According to the above-described reproduction image display processing, it is possible to display a series of screens created by the reproduction image creation processing as well as the order of the created screens. The display of a plurality of overwrite screen image data allows the operator to easily grasp operations involving the screen transition.

The screen generation apparatus according to the present embodiment can easily be applied to an information processing apparatus, thus increasing the performance of the information processing apparatus. The information processing apparatus to be mentioned here includes a server, a terminal installed at a call center, administrator's terminal, and the like.

Further, it is possible to provide a program that allows a computer constituting the screen generation apparatus to execute the above steps as a screen generation program. By storing the above program in a computer-readable storage medium, it is possible to allow the computer constituting the screen generation apparatus to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

An acquisition step corresponds to the communication data acquisition processing and communication data extraction processing in the embodiment. A generation step corresponds to the screen data generation processing, reproduction target data aggregation processing, transition number addition processing, and reproduction image creation processing in the embodiment. A first display step corresponds to the screen control processing in the embodiment. A second display step corresponds to the reproduction screen display processing in the embodiment. An acquisition section corresponds to the HTTP message observation section 111, HTTP analysis section 112, and communication data extraction section 121 in the embodiment. A generation section corresponds to the screen data generation section 122, reproduction target data aggregation section 311, transition number addition section 312, and reproduction image creation section 313 in the embodiment.

First data corresponds to the HTML form in the embodiment. A first screen corresponds to the Web screen in the embodiment. Second data corresponds to the response input, argument data, and button type in the embodiment. A second screen corresponds to the overwrite reproduction screen image data in the embodiment. Third data corresponds to the HTML form generated through the response input embedding processing and overwrite reproduction screen image data in the embodiment. Fourth data corresponds to the image data in the embodiment. Operation corresponds to the click of a button or input of a value in the embodiment. Operation order corresponds to the depression order, data transition management table A, and data transition management table B in the embodiment. Screen order corresponds to the screen transition order in the embodiment. An image emphasizing the operation position corresponds to the overwrite image in the embodiment. Operation position corresponds to the overwrite coordinate in the embodiment. Vicinity of the operation position corresponds to the data coordinate in the embodiment.

What is claimed is:

1. A non-transitory storage storing therein a display image generating program that causes a computer to execute a process, said process comprising:
acquiring error information stored in a storage when an input error occurs in response to an error input into a input item included in an input form provided by a server apparatus; and
displaying a display image including the input form with the error input, an error message corresponding to the error input into the input item, and an input rule regarding the input item.

2. The non-transitory storage according to claim 1, wherein the input rule is used for prompting a user of a client apparatus to make an appropriate input.

3. The non-transitory storage according to claim 1, wherein the displaying further comprises displaying time stamp information of the error input.

4. A method comprising:
acquiring error information stored in a storage when an input error occurs in response to an error input into a input item included in an input form provided by a server apparatus; and
displaying a display image including the input form with the error input, an error message corresponding to the error input into the input item, and an input rule regarding the input item.

5. An apparatus comprising:
a computer configured to:
acquire error information stored in a storage when an input error occurs in response to an error input into a input item included in an input form provided by a server apparatus. and
display a display image including the input form with the error input, an error message corresponding to the error input into the input item, and an input rule regarding the input item.
